(19) United States
(12) Patent Application Publication
(10) Pub. No.: US 2017/0078438 A1
(43) Pub. Date: Mar. 16, 2017

(54) COMMUNICATION DEVICE, COMMUNICATION METHOD, AND NON-TRANSITORY COMPUTER READABLE MEDIUM

(71) Applicant: KABUSHIKI KAISHA TOSHIBA, Tokyo (JP)

(72) Inventors: Takahiro YAMAURA, Kawasaki (JP); Yuta KOBAYASHI, Kawasaki (JP); Kensaku YAMAGUCHI, Kawasaki (JP); Takeshi ISHIHARA, Yokohama (JP)

(21) Appl. No.: 15/260,578

(22) Filed: Sep. 9, 2016

(30) Foreign Application Priority Data
Sep. 14, 2015 (JP) 2015-181166

(51) Int. Cl. H04L 29/08

(52) U.S. Cl. CPC H04L 67/2857; H04L 67/42

(57) ABSTRACT

According to one embodiment, a communication device including: a network interface configured to receive a frame from a client; first circuitry configured to determine whether or not the frame is a cache target which requires same content a predetermined number of times or more within a predetermined time period; and second circuitry configured to cache the content required by the frame in a case where the frame is the cache target.

### CROSS-REFERENCE TO RELATED APPLICATIONS

This application is based upon and claims the benefit of priority from Japanese Patent Application No. 2015-181166, filed Sep. 14, 2015; the entire contents of which are incorporated herein by reference.

### FIELD

Embodiments of the present invention relate to a communication device, a communication method and a non-transitory computer readable medium.

### BACKGROUND

Conventionally, proxy devices have been used as communication devices. In response to a request from a client to acquire content, a proxy device acquires the content by proxy from a server to store (cache) the content in a memory as a central processor or in a storage as a secondary storage and sends the cached content in return to the client.

The proxy device of related art equipped with a storage limited in a frequency of rewrite such as a flash memory has had a problem that a life of the storage is shortened if caching all contents. In a case where an upper limitation is imposed on a storage capacity of a memory to be mounted, unnecessary content cached needs to be written into the secondary storage or causes the need to delete old content, which disadvantageously degrades an efficiency.

On the other hand, the Pareto principle holds for video content delivery, and twenty percent of all contents occupy most of the traffic in a case. Moreover, in real-time delivery of the video content, a particular content viewing is instantaneously concentrated in some cases.

### BRIEF DESCRIPTION OF THE DRAWINGS

FIG. 1 is a diagram showing an example of a communication system including a communication device according to a first embodiment;

FIG. 2 is a diagram showing an example of a hardware configuration of the communication device according to the first embodiment;

FIG. 3 is a diagram showing an example of a functional configuration of the communication device according to the first embodiment;

FIG. 4 is a flowchart showing an example of an operation of the communication device according to the first embodiment;

FIG. 5 is a flowchart showing an example of the operation of the communication device according to the first embodiment;

FIG. 6 is a sequence diagram showing an example of a process flow of the communication device according to the first embodiment;

FIG. 7 is a sequence diagram showing an example of the process flow of the communication device according to the first embodiment;

FIG. 8 is a sequence diagram showing an example of the process flow of the communication device according to the first embodiment;

FIG. 9 is a diagram showing a functional configuration of a cache determinator in a communication device according to a second embodiment;

FIG. 10 is a diagram illustrating a Bloom filter;

FIG. 11 is a diagram showing a first usage method of the Bloom filter;

FIG. 12 is a diagram showing a second usage method of the Bloom filter;

FIG. 13 is a diagram showing a third usage method of the Bloom filter;

FIG. 14 is a diagram showing a fourth usage method of the Bloom filter;

FIG. 15 is a flowchart showing an example of an operation of a cache determinator according to the second embodiment;

FIG. 16 a diagram showing a specific example of the operation of the cache determinator according to the second embodiment;

FIG. 17 is a diagram showing a modification example of the cache determinator in FIG. 9;

FIG. 18 is a diagram showing a modification example of the cache determinator in FIG. 9;

FIG. 19 is a diagram showing an example of a functional configuration of a communication device according to a third embodiment;

FIG. 20 is a diagram showing an example of a cache information addition method according to the third embodiment;

FIG. 21 is a flowchart showing an example of an operation of the communication device according to the third embodiment;

FIG. 22 is a diagram showing an example of a functional configuration of a communication device according to a fourth embodiment;

FIG. 23 is a diagram showing a specific example of a key according to the fourth embodiment;

FIG. 24 is a diagram showing an example of a cache information addition method according to the fourth embodiment;

FIG. 25 is a sequence diagram showing an example of a process flow of the communication device according to the fourth embodiment;

FIG. 26 is a flowchart showing an example of an operation of the communication device according to the fourth embodiment;

FIG. 27 is a flowchart showing an example of the operation of the communication device according to the fourth embodiment;

FIG. 28 is a diagram showing an example of an operation of a cache determinator according to the fourth embodiment;

FIG. 29 is a diagram showing a modification example of FIG. 22;

FIG. 30 is a diagram showing a modification example of FIG. 22;

FIG. 31 is a diagram showing an example of a functional configuration of a communication device according to a fifth embodiment;

FIG. 32 is a diagram showing an example of a cache information addition method according to the fifth embodiment;

FIG. 33 is a flowchart showing an example of an operation of the communication device according to the fifth embodiment;

FIG. 34 is a diagram showing a modification example of FIG. 31;

FIG. 35 is a diagram showing an example of a functional configuration of a communication device according to a sixth embodiment;

FIG. 36 is a flowchart showing an example of an operation of the communication device according to the sixth embodiment; and

FIG. 37 is a flowchart showing an example of the operation of the communication device according to the sixth embodiment.

### DETAILED DESCRIPTION

According to one embodiment, a communication device including: a network interface configured to receive a frame from a client; first circuitry configured to determine whether or not the frame is a cache target which requires same content a predetermined number of times or more within a predetermined time period; and second circuitry configured to cache the content required by the frame in a case where the frame is the cache target. Hereinafter, a description is given of embodiments according to the present invention with reference to the drawings.

### First Embodiment

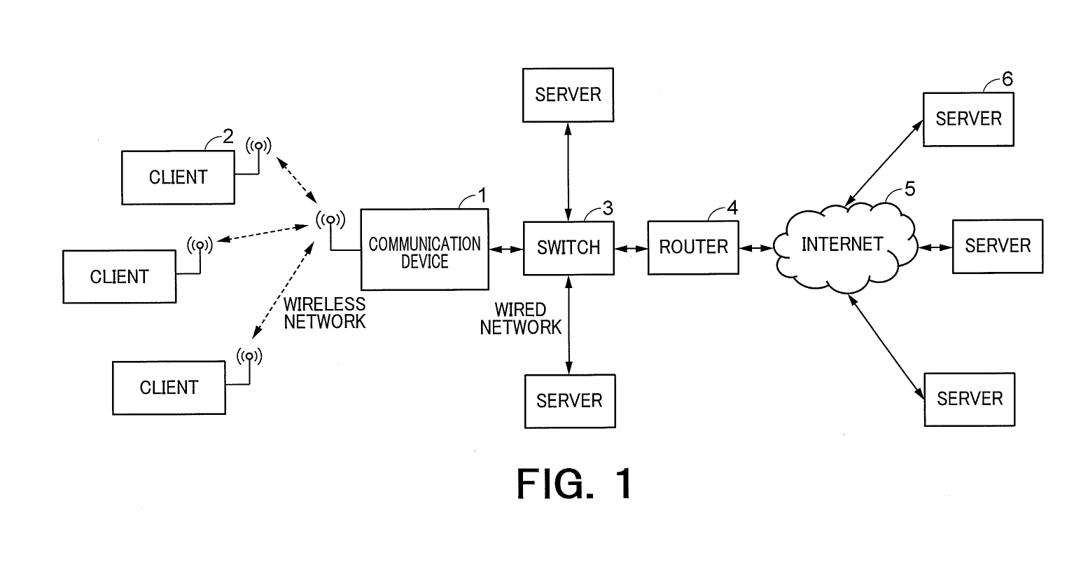

A description is given of a communication device 1 according to a first embodiment with reference to FIG. 1 to FIG. 8. A description is given below of a case where the communication device 1 acts as an access point in a wireless LAN. FIG. 1 is a diagram showing an example of a communication system including the communication device 1. The communication system includes the communication device 1 and plural clients 2 as shown in FIG. 1.

The communication device 1 is an access point provided with interfaces for a wireless network and wired network. The communication device 1 is connected with plural servers 6 via a switch 3, a router 4, and an Internet 5. The server 6 is a web server, for example. The communication device 1 is also connected with the plural clients 2 over the wireless network. The communication device 1 provides the client 2 with means for accessing equipment, such as the server 6, which is connected with the communication device 1 over the wired network.

The client 2, which is provided with a wireless network interface, transmits an HTTP request to require an acquisition of content via the communication device 1 over the wireless network to the server 6 and receives the required content from the server 6. The client 2, whose examples include, for example, a tablet, a smartphone, and a personal computer, includes a web browser for viewing a WWW (World Wide Web).

In the communication system like this, the communication device 1 acts as a transparent proxy. The communication device 1, when receiving the HTTP request directed to the server 6 from the client 2, acquires the content from the server 6 on behalf of the client 2 and sends the acquired content in return to the client 2. The communication device 1 has also a function to cache the acquired content in a memory or a storage.

More specifically, the communication device 1, when receiving the HTTP request based on an HTTP (Hypertext Transfer Protocol) directed to the server 6 from the web browser executed on the client 2, determines whether or not the required content is cached in the memory or the storage. If the content is cached, the communication device 1 transmits the cached content to the client 2. If the content is not cached, the communication device 1 acquires the required content from the server 6 and caches the acquired content to transmit it to the client 2. Note that packets based on an ARP (Address Resolution Protocol) and an ICMP (Internet Control Message Protocol) which are received by the communication device 1 but not directed to the device 1 are transferred to the server 6 in accordance with a routing.

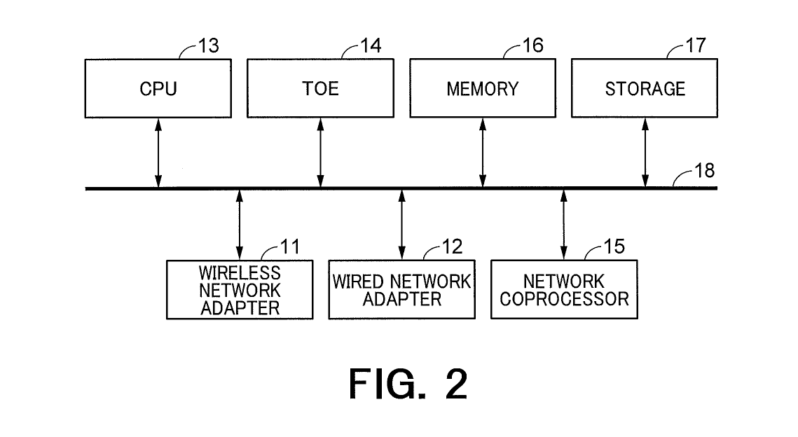

FIG. 2 is a diagram showing an example of a hardware configuration of the communication device 1 according to the embodiment. As shown in FIG. 2, the communication device 1 includes a wireless network adapter 11, a wired network adapter 12, a CPU 13, a TOE 14, a network coprocessor 15 a memory 16, a storage 17, and a bus 18.

The wireless network adapter 11 is a network adapter for communicating based on a wireless LAN standard defined by the IEEE 802.11b/a/g/n/p/ac/ah/ax or the like. The wireless network adapter 11 performs processes concerning transmission and reception in a physical layer (PHY) and a data link layer (MAC). The wireless network adapter 11 may be configured by circuitry as one example. The term “circuitry” may refer to not only electric circuits or a system of circuits used in a device but also a single electric circuit or a part of the single electric circuit.

The wired network adapter 12 is a network adapter for communicating based on Ethernet (registered trademark). The wired network adapter 12 performs processes concerning transmission and reception in the physical layer (PHY) and the data link layer (MAC). The wired network adapter 12 may be configured by circuitry as one example.

The CPU (Central Processing Unit) 13, which is circuitry, is a host processor for executing an application or an OS (Operating System) stored in the memory 16. The CPU executing a program achieves functions such as a network process not performed by the TOE 14 or the network coprocessor 15, an interface process with respect to the TOE 14 or the network coprocessor 15, management of the memory 16, a device driver for the storage 17, and accesses to the memory 16 and the storage 17. In the embodiment, the application executed by the CPU includes a proxy provided with a cache function.

The TOE (Transmission Control Protocol/Internet Protocol Offload Engine) 14 is a processor for performing a process of TCP/IP on behalf of the CPU 13. The TOE 14 may be a general or special purpose processor other than the CPU 13, or may be a special purpose hardware such as an FPGA (Field Programmable Gate Array) or an ASIC (Application Specific Integrated Circuit). The TOE 14 may also have a special purpose memory built therein.

The TOE 14, which is connected with the storage 17 via the bus 18, issues an instruction to the storage 17 to read and write data stored in the storage 17. For example, the TOE 14 reads out the data in the storage 17 and performs a transmission process of TCP/IP to output the data to the wireless network adapter 11 or the wired network adapter 12.

The network coprocessor 15, which is circuitry, is a processor for performing the network process on behalf of the CPU 13. The network coprocessor 15 may be a general or special purpose processor other than the CPU 13, or may be a special purpose hardware such as an FPGA (Field Programmable Gate Array) or an ASIC (Application Specific Integrated Circuit). The network coprocessor 15 may also have a special purpose memory built therein.

The network coprocessor 15 performs, for example, conversion between a wireless LAN frame defined by the IEEE802.11 and an Ethernet (registered trademark) frame, determination of a cache operation described below, allocation of the cache operation, a bridge process and the like. The network coprocessor 15 may be configured by circuitry as one example.

The memory 16 is connected via the bus 18 with the wireless network adapter 11, the wired network adapter 12, the CPU 13, the TOE 14, the network coprocessor 15, and the storage 17. The data is read out or written into the memory 16 by hardware modules connected thereto via the bus 18.

The storage 17, which is hardware storage, is an SSD (Solid State Drive) provided with a NAND flash memory, for example. The storage 17 is accessed via an interface such as an AHCI (Advanced Host Controller Interface), and a NVM Express. The storage 17 has the cached content stored therein.

The bus 18 connects the above hardware modules with each other. The bus 18 may be, for example, a PCI Express (registered trademark), a processor vendor-specified bus, or a uniquely designed bus. In the example in FIG. 2, the bus 18 is a common bus, but may be a bus connecting the hardware modules in a one to one manner. The bus 18 connects the hardware modules via a point-to-point connection, improving a processing speed of the communication device 1.

Note that the configuration of the communication device 1 is not limited to the configuration in FIG. 2. For example, one or more of the above hardware modules may be configured as a SoC (System on Chip). Specifically, the wireless network adapter 11 and the network coprocessor 15 may be configured as the SoC.

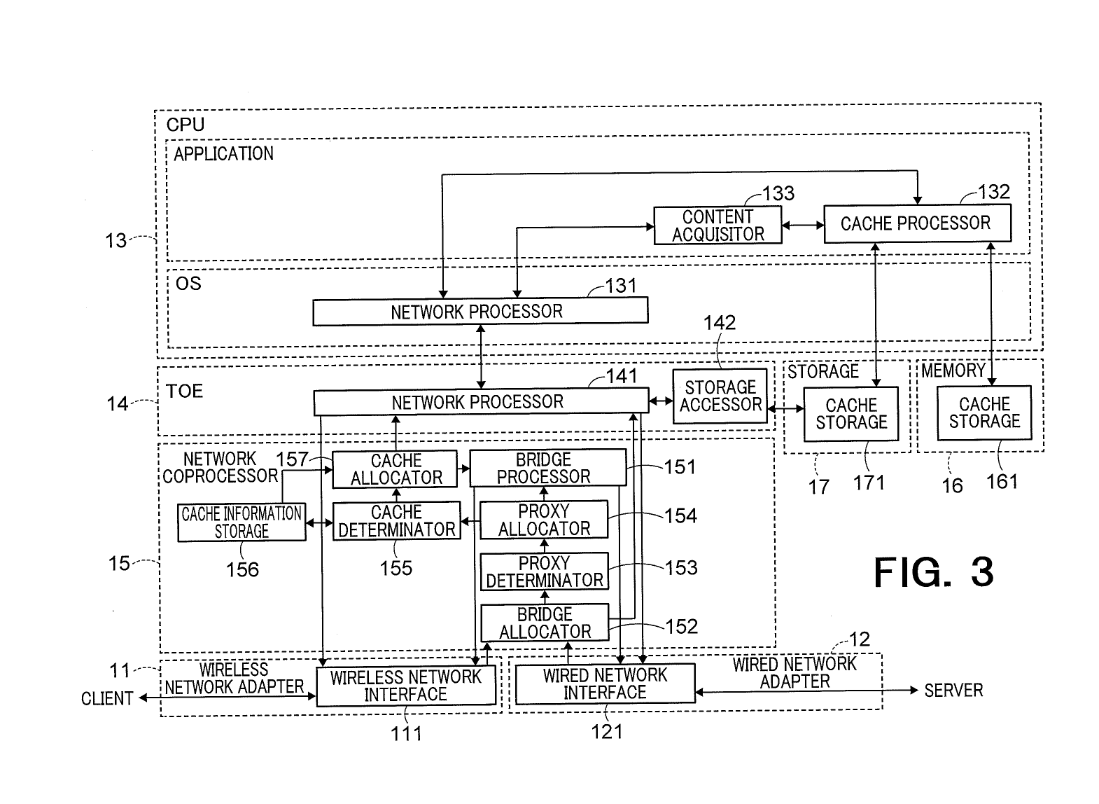

FIG. 3 is a diagram showing an example of a functional configuration of the communication device 1 according to the embodiment. The functional configurations shown in FIG. 3 are realized by corresponding hardware modules, respectively.

The wireless network adapter 11 includes a wireless network interface 111.

The wireless network interface 111 is a wireless network interface circuit connected via the wireless network with the client 2. The wireless network interface 111 performs protocol processes for the physical layer and data link layer in an OSI reference model. For example, the wireless network interface 111 performs the protocol process defined by the IEEE 802.11 or the like.

The wireless network interface 111 may perform all the protocol processes for the physical layer and data link layer. The wireless network interface 111 may perform a part of the protocol processes, and the CPU 13, TOE 14, network coprocessor 15 and the like may perform the rest of the protocol processes.

The wired network adapter 12 includes a wired network interface 121.

The wired network interface 121 is a wired network interface circuit connected via the wired network with the server 6. The wired network interface 121 performs the protocol process for the physical layer and data link layer in the OSI reference model. For example, the wired network interface 121 performs the protocol process defined by the Ethernet (registered trademark) or the like.

The wired network interface 121 may perform all the protocol processes for the physical layer and data link layer. The wired network interface 121 may perform a part of the protocol processes, and the CPU 13, TOE 14, network coprocessor 15 and the like may perform the rest of the protocol processes.

The memory 16 includes a cache storage 161.

The cache storage 161 is a storage area in the memory 16 for saving (caching) an HTTP header or content received from the server 6. The cache storage 161 saves the HTTP header and the content in an efficiently searchable data structure.

The storage 17 includes a cache storage 171.

The cache storage 171 is a storage area in the storage 171 for saving (caching) the HTTP header or content received from the server 6. The cache storage 171 saves the HTTP header and the content in an efficiently searchable data structure.

Note that the cache storage 161 and the cache storage 171 may be differently used depending on a frequency of being referred. For example, those with the higher frequency of being referred may be stored in the cache storage 161, and those with the lower frequency of being referred may be stored in the cache storage 171. The content may be controlled to be moved from the cache storage 161 to the cache storage 171 depending on the frequency of being referred.

The CPU 13 includes a network processor 131, a cache processor 132, and a content acquisitor 133.

The network processor 131 is realized by the CPU 13 executing the OS. In other words, the network processor 131 is a function of the OS.

The network processor 131 performs the protocol process not processed by the TOE 14. The network processor 131 also serves as an interface with an application. For example, the network processor 131 performs the protocol process of the ARP, an NDP (Neighbor Discovery Protocol), the ICMP and the like.

More specifically, if the communication device 1 receives the ARP packet directed thereto, the network processor 131 receives the received ARP packet to analyze a header of the received ARP packet and confirm an operation type of the ARP packet.

If the operation type is a request, the network processor 131 confirms a MAC address corresponding to an IP address requested, generates an ARP packet for reply, and transmits the generated ARP packet to the MAC address. If the operation type is a reply, the network processor 131 registers the ARP packet received in an ARP table.

The cache processor 132 is realized by the CPU 13 executing the application. In other words, the cache processor 132 is a function of the application (proxy).

The cache processor 132 determines whether or not the content required by the HTTP request from the client 2 is already cached. In other words, the cache processor 132 determines whether or not the required content is saved in the cache storage 161 or 171.

If the required content is already cached, the cache processor 132 reads out the required content from the cache storage 161 or 171, and transmits the read content via the network processor 131 or the like to the client 2.

On the other hand, if the required content is not cached, the cache processor 132 instructs the content acquisitor 133 to acquire the required content from the server 6. After that, the cache processor 132 receives the content or HTTP header acquired by the content acquisitor 133 from the server 6, and saves the received content or the like in the cache storage 161 or 171.

The content acquisitor 133 is realized by the CPU 13 executing the application. In other words, the content acquisitor 133 is a function of the application (proxy).

The content acquisitor 133 establishes a connection with the server 6 via the network processor 131 or the like in accordance with the instruction from the cache processor 132. The content acquisitor 133 transmits the HTTP request to the server 6 with which the connection is established, and receives a response to the HTTP request, that is, the content and the HTTP header from the server 6. The content acquisitor 133 passes the content and HTTP header acquired from the server 6 to the cache processor 132.

The TOE 14 includes a network processor 141, and a storage accessor 142.

The network processor 141 performs protocol processes for a network layer and transport layer. Specifically, for example, the network processor 141 performs the protocol processes of an IPv4, IPv6, TCP, UDP (User Datagram Protocol) and the like.

In a reception process of an IPv4 packet, the network processor 141 analyzes an IP header and confirms a version number to confirm whether or not a header checksum matches. In a transmission process of the IPv4 packet, the network processor 141 calculates the header checksum on the basis of information specified by an application or the like in an upper layer to generate the IP header.

The network processor 141, in communicating based on the TCP or the UDP, saves information concerning the communication as socket information in a memory (not shown) in the TOE 14. A socket means a terminal for communication and the application uses this socket to communicate with other device and the like. The socket information contains an IP address and port number of the communication device 1, an IP address and port number of another device with which the communication device 1 communicates, a state of the socket, and the like.

In a case of the TCP, the socket information further contains a sequence number received before or a sequence number to be transmitted from now, a window size of the communication device 1, a window size of another device with which the communication device 1 communicates, and the like.

In a reception process of a TCP segment, the network processor 141 scans a header of a received segment. The network processor 141 searches the memory (not shown) in the TOE 14 for the socket information matching a destination IP address, originating IP address, destination TCP port number, and originating TCP port number which are obtained by scanning, and performs a process depending on the state of the found socket information.

For example, if the state is “ESTABLISHED”, the network processor 141 confirms a flag of the TCP segment, confirms the sequence number, calculates checksum for the TCP, and, if the checksum matches, writes the data into a buffer area specified in the socket information and instructs transmission of an acknowledgement response (ACK) for the TCP.

In the state is “LISTEN”, the network processor 141 confirms the flag of the TCP segment. If a SYN flag is “1”, the network processor 141 newly creates the socket information in which the state is “SYN_RECEIVED”. The socket information is preferably connected by a hash table or the like for the purpose of easy search.

In a transmission process of the TCP segment, the network processor 141 reads the buffer area specified by the application in which transmission data is stored, and uses information read out from the socket information such as the IP address, port number, sequence number and window size to generate the TCP header. The buffer area specified by the application is the cache storage 161, for example. The network processor 141, in such a case of receiving the TCP segment including the data, uses the information read out from the socket information such as the IP address, port number, sequence number, and window size to transmit the ACK.

Note that if the protocol at the network layer for a received frame is not the IPv4 or the IPv6, or if the protocol at the transport layer is not the TCP or the UDP, the network processor 141 may perform a possible protocol process, and then, pass the processed frame to the network processor 131. The network processor 141 may also perform a flow control, congestion control or the like in the TCP.

The storage accessor 142 accesses the cache storage 171 in the storage 17 in accordance with the instruction from the cache processor 132. The storage accessor 142 can read out the data saved in the cache storage 171 to pass the data to the network processor 141, or save the data received from the network processor 141 in the cache storage 171.

The network coprocessor 15 includes a bridge processor 151, a bridge allocator 152, a proxy determinator 153, a proxy allocator 154, a cache determinator 155, a cache information storage 156, and a cache allocator 157.

The bridge processor 151 transfers the frame between the wireless network interface 111 and the wired network interface 121 (bridge process). Specifically, the bridge processor 151 transfers the frame received by the wireless network interface 111 to the wired network interface 121 for transmission or transfers the frame received by the wired network interface 121 to the wireless network interface 111 for transmission.

The bridge allocator 152 determines whether not the frames received by the wireless network interface 111 and wired network interface 121 are directed to the communication device-self. In other words, the bridge allocator 152 determines whether or not a destination MAC address of the received frame coincides with the MAC address of the communication device-self.

If directed to the communication device-self, the bridge allocator 152 passes the frame to the network processor 141 in the TOE 14. Then, the frame is processed by the network processor 141. On the other hand, if not directed to the communication device-self, the bridge allocator 152 passes the frame to the proxy determinator 153.

The proxy determinator 153 determines whether or not the frame passed from bridge allocator 152 is a proxy target. The proxy target means a frame that is a target to which the communication device 1 acts as the proxy device. The proxy target is set by a user of the communication device 1 specifying a protocol type or header information of the protocol.

For example, if the HTTP is specified as the protocol type of the proxy target, the proxy determinator 153 determines the proxy target as a frame for which the transport layer is TCP and a destination port is 80. This is because the HTTP usually waits for a request at the port of TCP port 80. The proxy determinator 153, after determination, passes the frame and a determination result to the proxy allocator 154.

The proxy allocator 154 allocates the frame to any one of the bridge processor 151 and the cache determinator 155 on the basis of the determination result by the proxy determinator 153.

The proxy allocator 154 passes the frame determined to be not the proxy target to the bridge processor 151. The frame passed to the bridge processor 151 is subjected to the bridge process by the bridge processor 151.

On the other hand, the proxy allocator 154 passes the frame determined to be the proxy target to the cache determinator 155.

The cache determinator 155 determines whether or not the frame passed from the proxy allocator 154 is to be subjected to a cache process. In other words, the cache determinator 155 determines whether or not the content required by the frame (HTTP request) is to be stored in the cache storage 161 or 171.

First, the cache determinator 155 determines whether or not the frame is a cache determination target.

The cache determination target means a frame that is a target to be subjected to the cache process or the determination on this process. The cache determination target is the first frame after establishing a TCP connection, for example. In this case, the determination on the cache determination target is performed one time for each connection.

Next, the cache determinator 155 determines whether or not the frame is a cache target (cache determination). The cache target means a frame for which the content acquired in response to a request from the frame is cached. The cache determinator 155, if receiving the frame (HTTP request) requiring the same content a predetermined number of times or more within a predetermined time period, for example, determines that the relevant frame is the cache target.

More specifically, the cache determination is performed by determining whether or not the destination IP address receives the same frame (request) a predetermined number of times or more within a predetermined time period. Here, assuming that the predetermined time period is one hour and the predetermined number of times is two times, if the frame subjected to the cache determination is the second or subsequent frame having the same destination IP address which is received within one hour, it is determined to be the cache target.

The cache determinator 155 passes the frame to the cache allocator 157. The cache determinator 155 outputs cache information including the determination result and information accompanying thereto. The cache information includes the determination result, the destination IP address for identifying the TCP connection, the TCP port number, the originating IP address, and a set of TCP port numbers.

The cache information storage 156, which is constituted by the memory (not shown) in the network coprocessor 15, stores the cache information output by the cache determinator 155 for each connection. The cache information stored in the cache information storage 156 is referred to by the cache allocator 157. The cache information stored in the cache information storage 156 is also deleted in disconnecting the connection.

The cache allocator 157 allocates the frame passed from the cache determinator 155 to any one of the bridge processor 151 and the network processor 141 on the basis of the cache information output by the cache determinator 155 and the cache information stored in the cache information

If the frame is the cache determination target and is the cache target, that is, if the cache determinator 155 determines that content required by the frame is cached, the cache allocator 157 passes the frame to the network processor 141. After that, the frame is subjected to the protocol process by the network processor 141 or 131.

If the frame is the cache determination target and is not the cache target, that is, if the cache determinator 155 determines that content required by the frame is not cached, the cache allocator 157 passes the frame to the bridge processor 151. After that, the frame is subjected to the bridge process by the bridge processor 151.

If the frame is not the cache determination target, the cache allocator 157 reads out from the cache information storage 156 the cache information on the connection of which IP address and TCP port number contained in the frame match.

If the determination result of the cache determination included in the read out cache information is true (that is, if the frame of which the cache information is generated is the cache target), the cache allocator 157 passes the frame to the network processor 141. After that, the frame is subjected to the protocol process by the network processor 141 or 131.

If the determination result of the cache determination included in the read out cache information is false (that is, if the frame of which the cache information is generated is not the cache target), the cache allocator 157 passes the frame to the bridge processor 151. After that, the frame is subjected to the bridge process by the bridge processor 151.

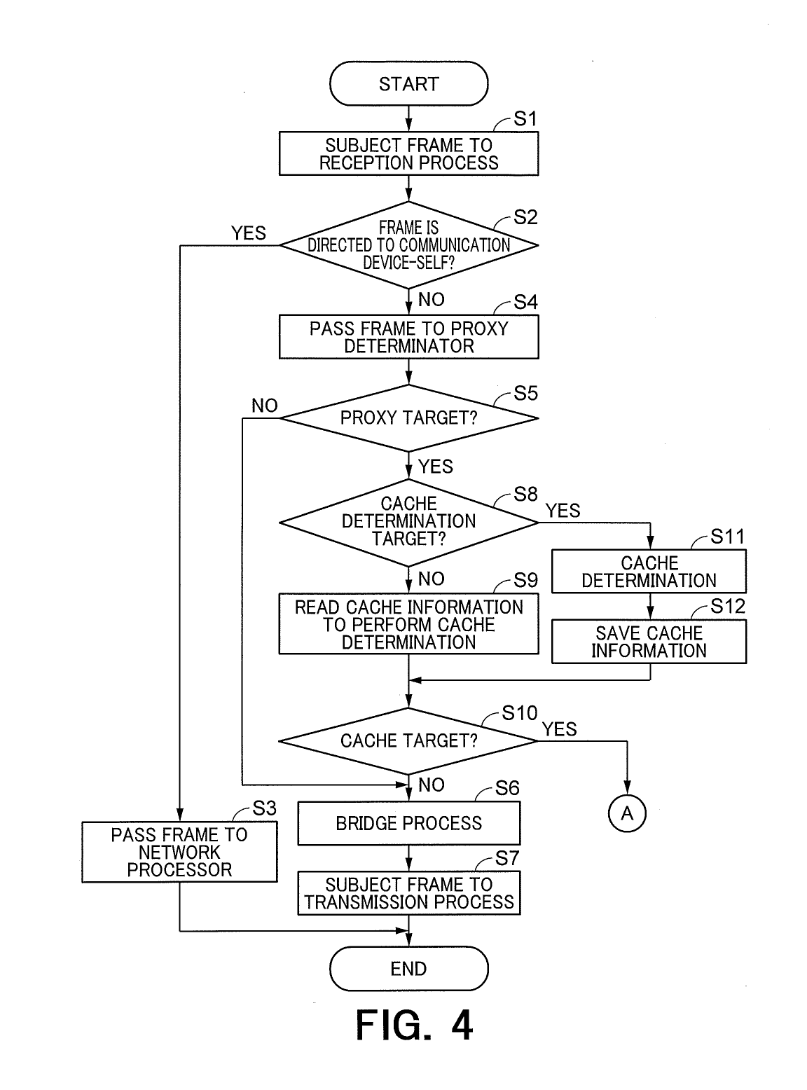

Next, a description is given of an operation of the communication device 1 according to the embodiment with reference to FIG. 4 to FIG. 8

FIG. 4 is a flowchart showing an example of an operation of the communication device 1. Hereinafter, a description is given of an operation a case where a wireless network interface 111 receives the frame from the client 2.

The wireless network interface 111, when receiving the frame from the client 2, subjects the received frame to the reception process, that is, the protocol processes for the physical layer and data link layer (step S1). The wireless network interface 111 passes the frame obtained through the reception process to the bridge allocator 152.

Next, the bridge allocator 152 determines whether or not the frame is directed to the communication device-self (step S2). Specifically, the bridge allocator 152 determines whether or not a destination MAC address of the frame coincides with the MAC address of the communication device-self.

If the frame is directed to the communication device-self (YES at step S2), that is, if the destination MAC address of the frame coincides with the MAC address of the communication device-self, the bridge allocator 152 passes the frame to the network processor 141 (step S3).

The network processor 141 having received the frame from the bridge allocator 152 subjects the frame to the protocol processes for the network layer and transport layer, and passes an obtained message via the network processor 131 to the application. The message is processed by the application.

On the other hand, if the frame is not directed to the communication device-self (NO at step S2), that is, if the destination MAC address of the frame does not coincide with the MAC address of the communication device-self, the bridge allocator 152 passes the frame to the proxy determinator 153 (step S4).

The proxy determinator 153 determines whether or not the frame received from bridge allocator 152 is the proxy target to pass the frame and the determination result to the proxy allocator 154 (step S4). Here, assume that the proxy target is the frame for which the transport layer is TCP and a destination port is 80.

If the frame is not the proxy target (NO at step S5), the proxy allocator 154 passes the frame to the bridge processor 151. Then, the frame is subjected to the bridge process by the bridge processor 151 (step S6). In other words, the frame is transferred to the wired network interface 121.

The wired network interface 121 having received the transferred frame subjects the received frame to the transmission process, that is, the protocol processes for the physical layer and data link layer (step S7). The wired network interface 121 transmits the frame obtained through the transmission process to the server 6 or the like.

On the other hand, if the frame is the proxy target (YES at step S5), the proxy allocator 154 passes the frame to the cache determinator 155.

The cache determinator 155 having received the frame determines firstly whether or not the received frame is the cache determination target (step S8).

If the received frame is the second or subsequent frame after establishing the connection, that is, if the received frame contains a segment subsequent to the SYN segment, the cache determinator 155 determines that the frame is not the cache determination target (NO at step S8) and passes the frame and the determination result to the cache allocator 157.

Then, the cache allocator 157 reads out from the cache information storage 156 the cache information on the connection the same as the frame received, refers to the determination result included in the read cache information, and determines whether or not the frame corresponding to the read cache information is the cache target (cache determination).

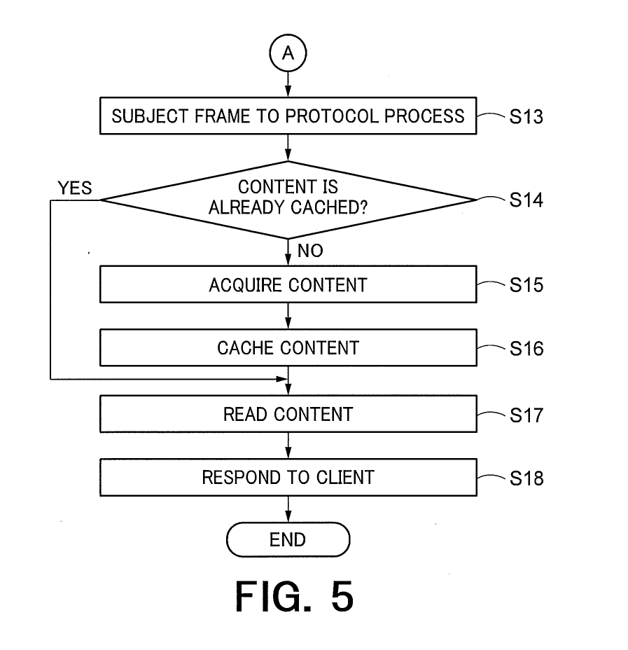

If the corresponding frame is not the cache target (NO at step S10), the process goes to step S6. The subsequent process is as described above. On the other hand, if the corresponding frame is the cache target (YES at step S10), the process goes to step S13. The process at step S13 and subsequent steps is described with reference to FIG. 5.

In contrast to this, at step S8, if the received frame is the first frame after establishing the connection, that is, if the received frame contains the SYN segment, the cache determinator 155 determines that the frame is the cache determination target (YES at step S8) and determines whether or not the frame is the cache target (cache determination) (step S11).

After the cache determination, the cache determinator 155 generates the cache information on the received frame to save the generated information in the cache information storage 156 (step S12). Then, the cache determinator 155 passes the frame and the determination result to the cache allocator 157.

If the frame received by the cache allocator 157 is not the cache target (NO at step S10), the process goes to step S6. The subsequent process is as described above. On the other hand, if the frame received by the cache allocator 157 is the cache target (YES at step S10), the process goes to step S13.

Next, the process at step S13 and subsequent steps is described with reference to FIG. 5. The process at step S13 and subsequent steps is a process in the case where the frame is the cache target.

If the frame is the cache target (YES at step S10), the cache allocator 157 passes the frame to the network processor 141 in the TOE 14. The network processor 141 subjects the frame received to the protocol process (step S13). The network processor 141 passes the obtained message to the network processor 131 in the OS.

The network processor 131 acts as the interface between the applications to pass the message received from the network processor 141 to the cache processor 132 of the application. Note that the network processor 131 may perform the protocol process not processed by the network processor 141.

If the message is the HTTP request to require an acquisition of content, the cache processor 132 having received the message determines whether or not the required content is already cached (step S14).

If the required content is not cached (NO at step S14), the cache processor 132 instructs the content acquisitor 133 to acquire the content.

The instructed content acquisitor 133 transmits the HTTP request to the server 6 at the destination IP address of the message via the network processors 131 and 141 and the wired network interface 121, and acquires the content required by the client 2 (step S15). The content acquisitor 133 passes the acquired content to the cache processor 132.

The cache processor 132 having received the content caches the received content (step S16). In other words, the cache processor 132 saves the received content in the cache storage 161 or 171.

After caching the content or if the content is cached already (YES at step S14), the cache processor 132 reads out the cached content (step S17) and passes the read content to the network processor 131.

After that, the network processors 131 and 141 and the wireless network interface 111 perform predetermined protocol processes to generate the frames including the content, and the wireless network interface 111 responds to the client 2 (step S18). In other words, the network interface 111 transmits the generated frame to the client 2.

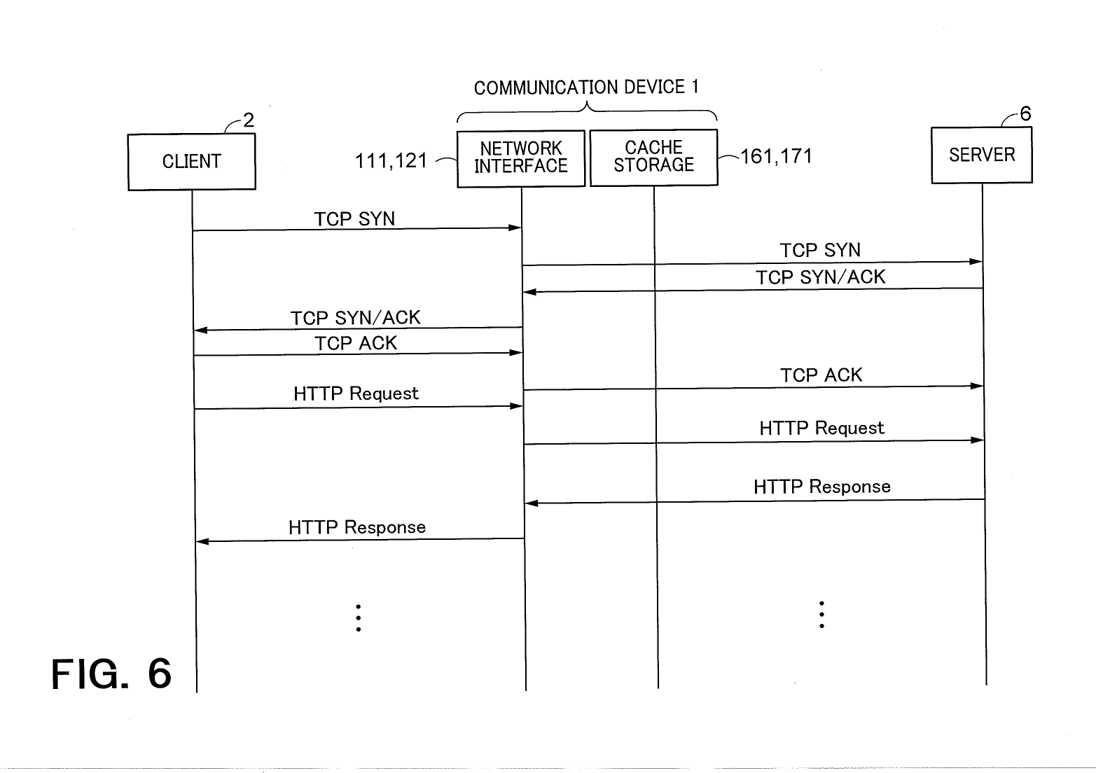

Here, FIG. 6 to FIG. 8 each are a sequence diagram showing an example of a process flow between the communication device 1, the client 2, and the server 6. The network interface in each of FIG. 6 to FIG. 8 is a name collectively for the wireless network interface 111 and the wired network interface 121.

FIG. 6 is a sequence diagram in the case where the frame received by the communication device 1 is not the proxy target or not the cache target.

In this case, the communication device 1 subjects the frame to the bridge process, and thus, the client 2 and the server 6 directly transmit and receive the message via the communication device 1 as shown in FIG. 6. In addition, the communication device 1 does not cache the content required by the HTTP request.

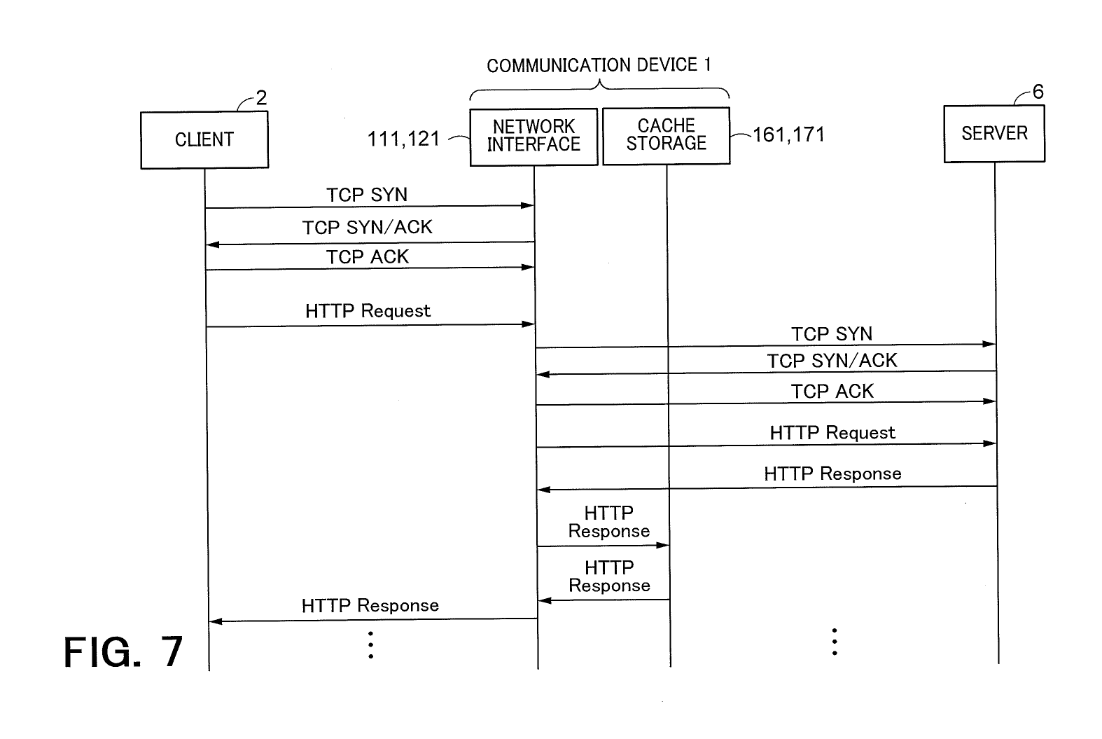

FIG. 7 is a sequence diagram in the case where the frame received by the communication device 1 is the proxy target and the content required by the frame is not cached.

In this case, as shown in FIG. 7, after the connection is established between the client 2 and the communication device 1, the connection is established between the communication device 1 and the server 6. Then, the communication device 1 receives the content required by the client 2 from the server 6 to cache the content in the cache storage 161 or 171 before responding to the client 2.

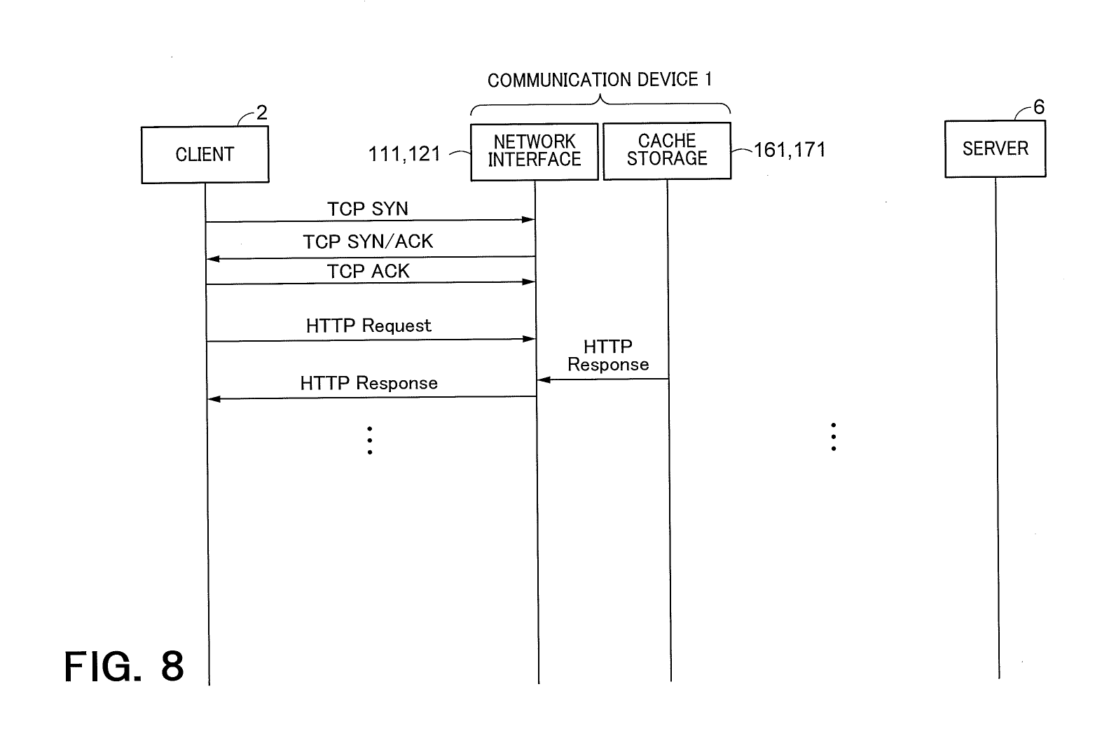

FIG. 8 is a sequence diagram in the case where the frame received by the communication device 1 is the proxy target and the content required by the frame is already cached.

In this case, as shown in FIG. 8, although the connection is established between the client 2 and the communication device 1, the connection is not established between the communication device 1 and the server 6. Then, the communication device 1 reads out the content required by the client 2 from the cache storage 161 or 171 and responds to the client 2.

As described above, the communication device 1 according to the embodiment caches only the content required by the client 2 a predetermined number of times or more within a predetermined time period. The content required a predetermined number of times or more within a predetermined time period corresponds to popular content.

In this way, the communication device 1 according to the embodiment can reduce the frequency of rewrite into the storage 17 to extend the life of the storage 17 by caching only the popular content.

Additionally, an amount of the cached content is reduced, which decreases the need to write the data from the memory 16 into the storage 17 or to delete the old content saved in the memory 16. Therefore, the communication device 1 according to the embodiment can efficiently operate even if a limitation is imposed on a storage capacity of the memory 16.

### Second Embodiment

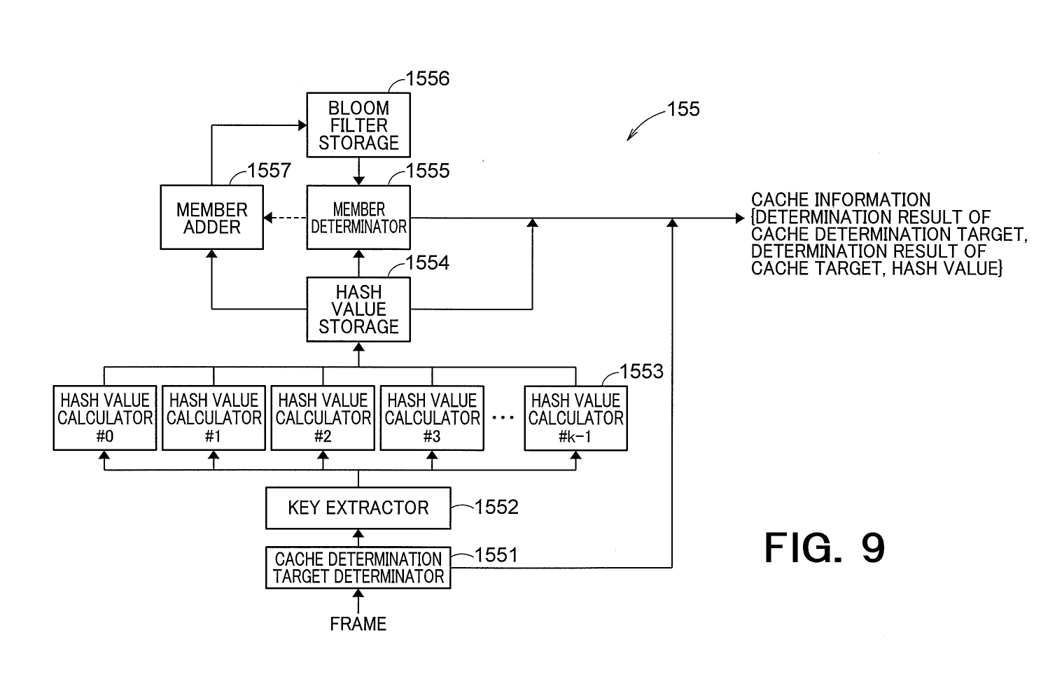

A description is given of the communication device 1 according to a second embodiment with reference to FIG. 9 to FIG. 18. In the embodiment, a description is given of the communication device 1 in which the cache determinator 155 uses a Bloom filter to perform the cache determination.

FIG. 9 is a diagram showing an example of a functional configuration of the cache determinator 155 according to the embodiment.

As shown in FIG. 9, the cache determinator 155 includes a cache determination target determinator 1551, a key extractor 1552, plural hash value calculators 1553, a hash value storage 1554, a member determinator 1555, a Bloom filter storage 1556, and a member adder 1557.

The cache determination target determinator 1551 determines whether or not the frame is the cache determination target. In other words, the cache determination target determinator 1551 performs the determination on the basis of whether or not a payload of TCP contains the HTTP request such as “GET” or “POST” and whether or not the SYN segment is contained in the frame. The determination may be performed by use of the SYN flag or by referring a state of the connection stored in a storage which is provided for storing the state for each connection.

The key extractor 1552 extracts a key used for the cache determination from the frame. The key is a destination IP address contained in the IP header of the frame, for example. The key extractor 1552 analyzes a header of the Ethernet or IEEE 802.11 that is the protocol at the data link layer and a header of the IPv4 or IPv6 that is the protocol at the network layer to extract the destination IP address.

The hash value calculator 1553 calculates a hash function to calculate a hash value of the key extracted by the key extractor 1552. The cache determinator 155 includes “k” hash value calculators 1553 which operate in parallel. The hash value calculators 1553 calculate the hash functions different from each other. Therefore, “k” hash values in total are calculated.

If the network coprocessor 15 is a multi-core processor, the hash value calculators 1553 are preferably constituted by cores different from each other. If the network coprocessor 15 is the FPGA or the ASIC, the hash value calculators 1553 are preferably configured as circuits different from each other.

The hash value storage 1554 is a buffer to transitorily store “k” hash values calculated by “k” hash value calculators 1553. The hash value storage 1554 may be constituted by the memory (not shown) in the multi-core processor 15 or may be constituted by an SRAM external to the multi-core processor 15 or the like.

The member determinator 1555 compares “k” hash values stored in the hash value storage 1554 with a set stored in the Bloom filter storage 1556 to determine whether no not the frame is a member. As a result of this, a frame having a key (destination IP address) is determined to be a member if a frame having the same key (destination IP address) has been received, and determined to be not a member if not received. This determination corresponds to the cache determination.

The Bloom filter storage 1556 stores a Bloom filter. The Bloom filter storage 1556 may be constituted by the memory (not shown) in the multi-core processor 15 or may be constituted by an SRAM external to the multi-core processor 15 or the like.

The member adder 1557 adds “k” hash values stored in the hash value storage 1554 to a Bloom filter set to add the frame as a member of the Bloom filter.

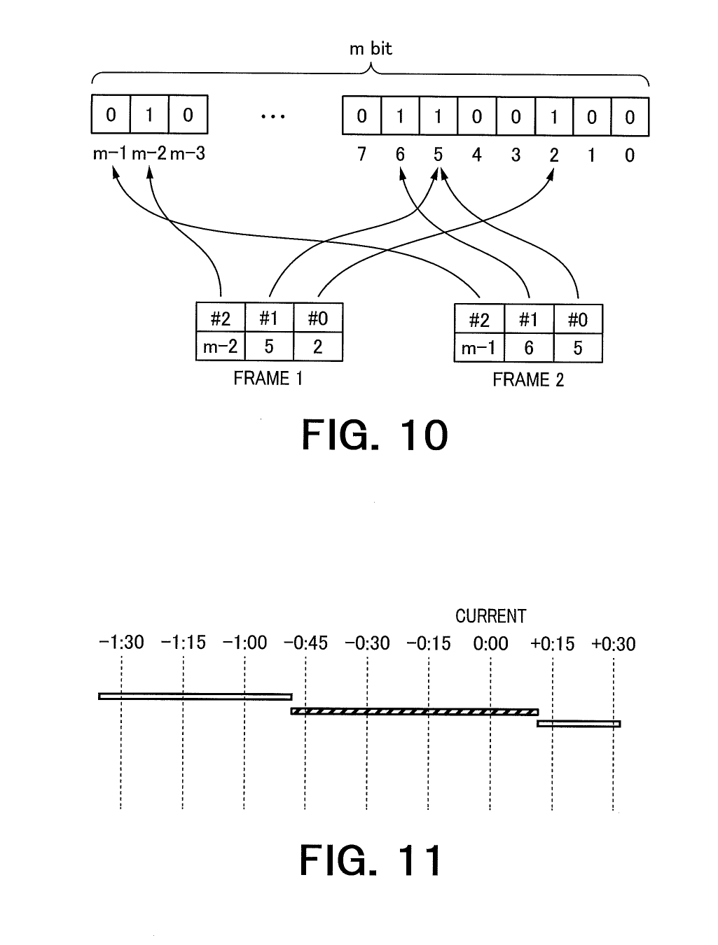

Here, FIG. 10 is a diagram illustrating the Bloom filter. As shown in FIG. 10, the Bloom filter contains a bit array of “m” bits. Each bit of the Bloom filter has a value of 1 or 0. This Bloom filter corresponds to a set of bit numbers of bits having a bit value of 1. In an example in FIG. 10, a value of each of the 2nd, 5th, 6th and m−2nd bits is 1. Therefore, the Bloom filter in FIG. 10 corresponds to a set having 2, 5, 6, and m−2.

For example if k=3, three hash value calculators 1553 calculate three hash values #0, #1, and #2 from the key of the frame. As shown in FIG. 10, if the hash values calculated from a key of a frame 1 are #0=2, #1=5, and #2=m−2, the hash values calculated from the key of the frame 1 are contained in the Bloom filter set in FIG. 10. In this case, the member determinator 1555 determines that the frame 1 is a member of the Bloom filter in FIG. 10.

On the other hand, if the hash values calculated from a key of a frame 2 are #0=5, #1=6, and #2=m−1, the hash values #2 calculated from the key of the frame 2 are not contained in the Bloom filter set in FIG. 10. In this case, the member determinator 1555 determines that the frame 2 is not a member of the Bloom filter in FIG. 10.

The member adder 1557 adds the hash values for the frame determined to be not a member by the member determinator 1555 to the Bloom filter set. Specifically, the member adder 1557 updates a value of the m−1st bit of the Bloom filter in FIG. 10 to 1 to add the frame 2 to the member of the Bloom filter.

The Bloom filter storage 1556 can store one or more Bloom filters like this. The number of the Bloom filters used for the cache determination may be one or more. Further, one Bloom filter may be continuously used, or the Bloom filter used may be changed at a predetermined timing.

FIG. 11 is a diagram showing a first usage method of the Bloom filter. In an example in FIG. 11, the member adder 1557 adds a member to the Bloom filters for one hour. The Bloom filter used is also switched every one hour. The member determinator 1555 performs the determination by use of the Bloom filter which is being updated at a determination time. According to the method in FIG. 11, the Bloom filter can easily managed.

FIG. 12 is a diagram showing a second usage method of the Bloom filter. In an example in FIG. 12, the member adder 1557 adds a member to the Bloom filters for fifteen minutes. The Bloom filter used is also switched every fifteen minutes. The member determinator 1555 performs the determination by use of the most recent four Bloom filters from the current time. Specifically, the member determinator 1555 performs member determination by use of a Bloom filter by an OR between four Bloom filters to output as the determination result of the cache determination. According to the second usage method, a false positive incidence immediately before switching the Bloom filter can be decreased as compared to the first usage method.

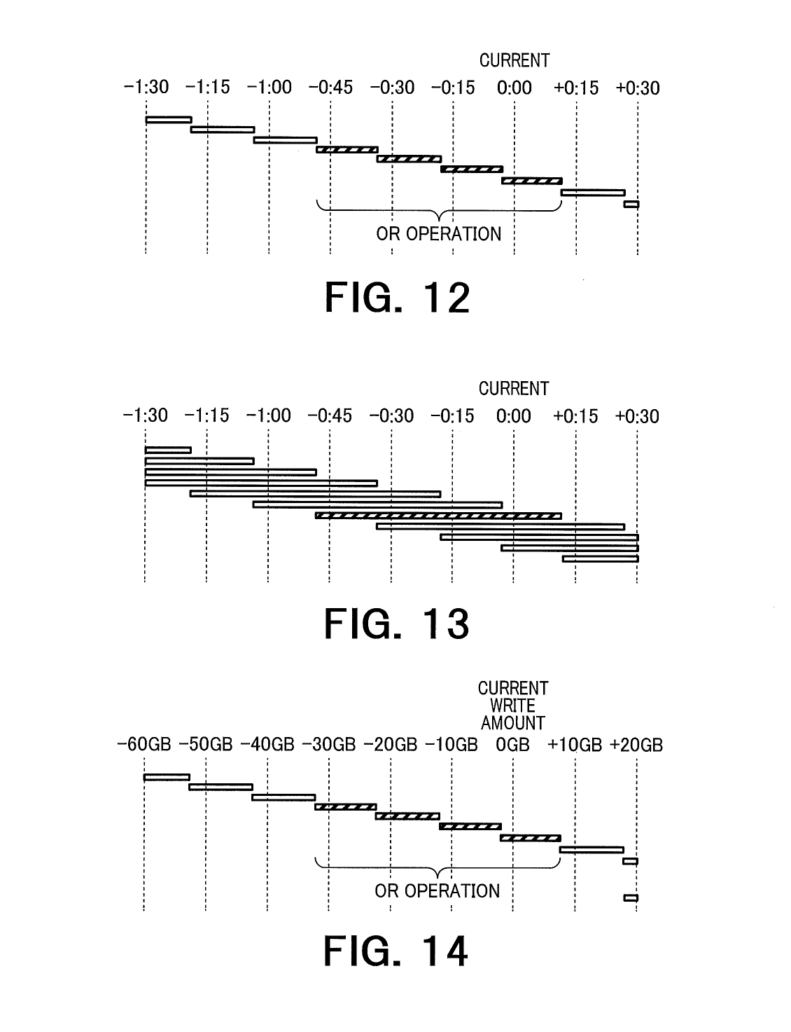

FIG. 13 is a diagram showing a third usage method of the Bloom filter. In an example in FIG. 13, the member adder 1557 adds a member to the Bloom filters for one hour. The Bloom filter used is also switched every fifteen minutes. The member determinator 1555 performs the determination by use of the Bloom filter being updated for the longest time of the Bloom filters which are being updated at a determination time. According to the third usage method, a negative incidence immediately after switching the Bloom filter can be decreased as compared to the first usage method.

FIG. 14 is a diagram showing a fourth usage method of the Bloom filter. The fourth usage method is different from the second usage method in the switching timing of the Bloom filter. In an example in FIG. 14, the member adder 1557 adds members to the Bloom filters until a storage amount (write amount) reaches 10 GB. In addition, every time the storage amount for each Bloom filter reaches 10 GB, the Bloom filter used is switched. The member determinator 1555 performs the determination by use of the most recent four Bloom filters. Specifically, the member determinator 1555 performs member determination by use of a Bloom filter by an OR between four Bloom filters to output as the determination result of the cache determination. According to the fourth usage method, a false positive incidence immediately before switching the Bloom filter can be decreased as compared to the first usage method.

Note that the methods for switching the Bloom filter using the time or the number of bytes are described above, but the Bloom filter usage method is not limited to the above methods. For example, the number of requests or the like may also be used to switch the Bloom filter.

The cache determinator 155 according to the embodiment described above outputs as the cache information the determination result output by the cache determination target determinator 1551, the set of “k” hash values stored by the hash value storage 1554, and the determination result output by the member determinator 1555. The cache information output by the cache determinator 155 is stored in the cache information storage 156 as is in the first embodiment. In the embodiment, the cache information storage 156 preferably has the data structure of the hash table and the like such that the cache information can be searched at a high speed.

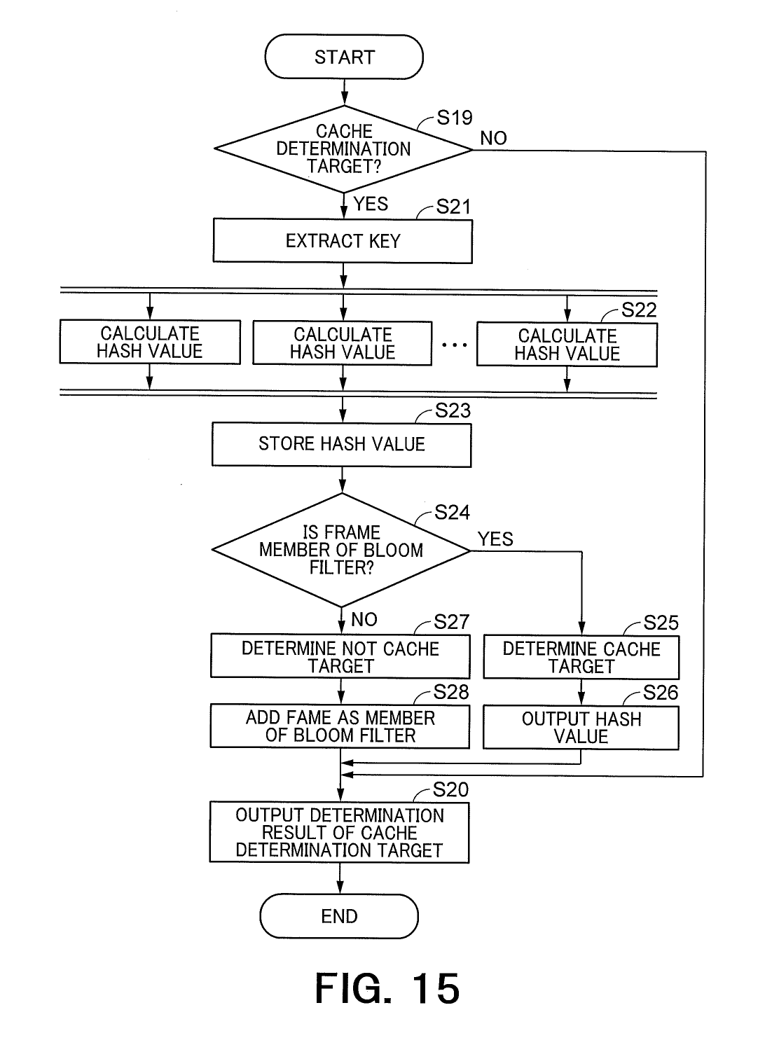

Next, a description is given of an operation of the cache determinator 155 with reference to FIG. 15. FIG. 15 is a flowchart showing an operation of the cache determinator according to the embodiment.

When the cache determinator 155 receives the frame from the proxy allocator 154, the cache determination target determinator 1551 firstly determines whether or not the frame is the cache determination target (step 19).

If the frame is not the cache determination target (NO at step S19), the cache determination target determinator 1551 outputs the determination result (step S20) and the process ends.

On the other hand, if the frame is the cache determination target (YES at step S19), the cache determination target determinator 1551 passes the frame to the key extractor 1552. Then, the key extractor 1552 analyzes the frame to extract the key (step S21). The key extractor 1552 passes the extracted key to hash value calculators 1553.

Next, each hash value calculator 1553 calculates the hash value from the key (step S22). The calculated “k” hash values are stored in the hash value storage 1554 (step S23).

Subsequently, the member determinator 1555 determines whether or not the frame is a member of the Bloom filter (step S24). In other words, the member determinator 1555 refers to the Bloom filter storage 1556 to determine whether or not “k” hash values stored in the hash value storage 1554 are contained in the Bloom filter set.

If the frame is a member of the Bloom filter (YES at step S24), that is, “k” hash values all are contained in the Bloom filter set, the member determinator 1555 determines that the frame is the cache target and outputs the determination result (step S25).

Then, the hash value storage 1554 outputs “k” stored hash values and is reset (step S26). After that, the process goes to step S20.

If the frame is not a member of the Bloom filter (NO at step S24), that is, at least one of “k” hash values is not contained in the Bloom filter set, the member determinator 1555 determines that the frame is not the cache target and outputs the determination result (step S27).

The member determinator 1555 also notifies the determination result to the member adder 1557. The member adder 1557 notified adds the frame to the member of the Bloom filter (step S28). In other words, the member adder 1557 adds “k” hash values stored in the hash value storage 1554 to the Bloom filter set. This causes the Bloom filter to be updated.

Then, the member adder 1557 resets the hash value storage 1554. At this time, the hash value storage 1554 may output the hash value. After that, the process goes to step S20.

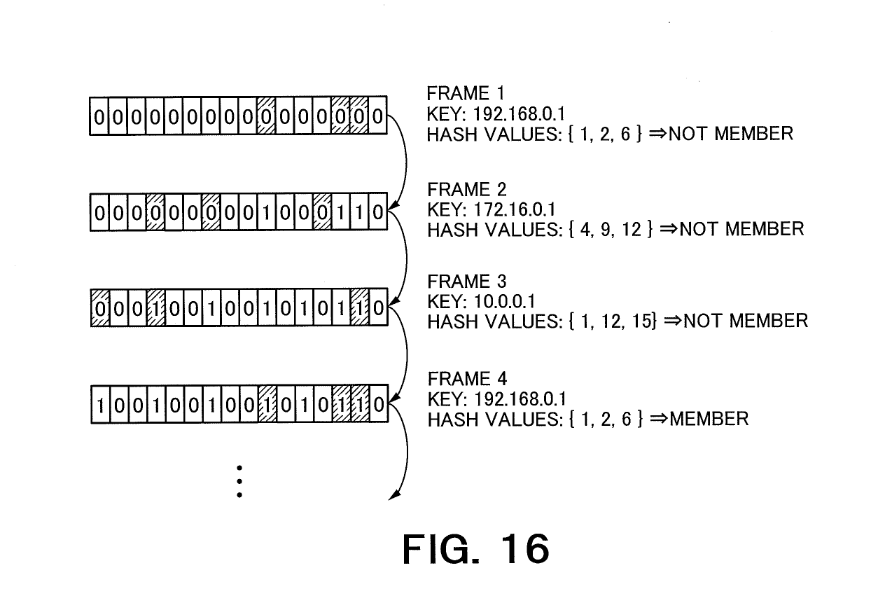

FIG. 16 is a diagram showing a specific example of the operation of the cache determinator 155 according to the embodiment. In an example in FIG. 16, the Bloom filter is a bit array of 16 bits and k=3. Hereinafter, assume that the cache determinator 155 receives the frames 1 to 4 in this order which contain the TCP segment having the destination port number 80. In other words, any of the frames 1 to 4 is the cache determination target. Further, as shown in FIG. 16, it is an example in which the Bloom filter is initialized at the time before receiving the frame. The initialization of the Bloom filter means the all bit values are set to 0 to set the Bloom filter to an empty set.

When the cache determinator 155 receives the frame 1, the key extractor 1552 extracts the key (destination IP address), three hash value calculators 1553 respectively calculate the hash values, and the hash value storage 1554 stores the hash values. Here, assume that a key of the frame 1 is “192.168.0.1” and hash values are {1, 2, 6}.

Since the all bit values of the Bloom filter are 0, the hash values {1, 2, 6} for the frame 1 are not contained in the Bloom filter set. Therefore, the member determinator 1555 determines that the frame 1 is not a member. Then, the member adder 1557 adds the frame 1 to the member of the Bloom filter. In other words, the member adder 1557 sets the 1st, 2nd, and 6th bits of the Bloom filter to 1. After that, the hash value storage 1554 is reset. As a result, the frame 1 is subjected to the bridge process.

When the cache determinator 155 receives the frame 2, the key extractor 1552 extracts the key (destination IP address), three hash value calculators 1553 respectively calculate the hash values, and the hash value storage 1554 stores the hash values. Here, assume that a key of the frame 2 is “172.16.0.1” and hash values are {4, 9, 12}.

Since the 1st, 2nd, and 6th bits of the Bloom filter are 1 and other bits are 0, the hash values {4, 9, 12} for the frame 2 are not contained in the Bloom filter set.

Therefore, the member determinator 1555 determines that the frame 2 is not a member. Then, the member adder 1557 adds the frame 2 to the member of the Bloom filter. In other words, the member adder 1557 sets the 4th, 9th, and 12th bits of the Bloom filter to 1. After that, the hash value storage 1554 is reset. As a result, the frame 2 is subjected to the bridge process.

When the cache determinator 155 receives the frame 3, the key extractor 1552 extracts the key (destination IP address), three hash value calculators 1553 respectively calculate the hash values, and the hash value storage 1554 stores the hash values. Here, assume that a key of the frame 3 is “10.0.0.1” and hash values are {1, 12, 15}.

Since the 1st, 2nd, 4th, 6th, 9th, and 12th bits of the Bloom filter are 1 and other bits are 0, the hash value {15} for the frame 2 is not contained in the Bloom filter set. Therefore, the member determinator 1555 determines that the frame 3 is not a member. Then, the member adder 1557 adds the frame 3 to the member of the Bloom filter. In other words, the member adder 1557 sets the 15th bit of the Bloom filter to 1. The 1st and 12th bits of the Bloom filter are already set to 1, and thus, are not changed. After that, the hash value storage 1554 is reset. As a result, the frame 3 is subjected to the bridge process.

When the cache determinator 155 receives the frame 4, the key extractor 1552 extracts the key (destination IP address), three hash value calculators 1553 respectively calculate the hash values, and the hash value storage 1554 stores the hash values. Here, assume that a key of the frame 4 is “192.168.0.1”. In this case, hash value are {1, 2, 6}. The frame 4 corresponds to the second frame requiring the content from the same host as the frame 1.

Since 1st, 2nd, 4th, 6th, 9th, 12th, and 15th bits of the Bloom filter are 1 and other bits are 0, the hash values {1, 2, 6} for the frame 4 are all contained in the Bloom filter set. Therefore, the member determinator 1555 determines that the frame 4 is a member. After that, the hash value storage 1554 is reset. As a result, the frame 4 is subjected to the cache process. In other words, the content required by the frame 4 is stored in the cache storage 161 or 171.

After this, when the communication device 1 receives from the client 2 the frame containing the TCP segment having the destination IP address of “192.168.0.1” and the destination port number 80, if the required content is cached in the cache storage 161 or 171, the cached content is sent from the cache storage 161 or 171 in return to the client 2. If the required content is not yet cached, the content is acquired from the server 6 to be cached in the cache storage 161 or 171.

As described above, the cache determinator 155 according to the embodiment can perform the cache determination by use of the Bloom filter. This can speed up the cache determination.

Note that the communication device 1 performs the cache process in the case where the same content is required two or more times in the above description, but may be configured to perform the cache process in a case where the same content is required three or more times.

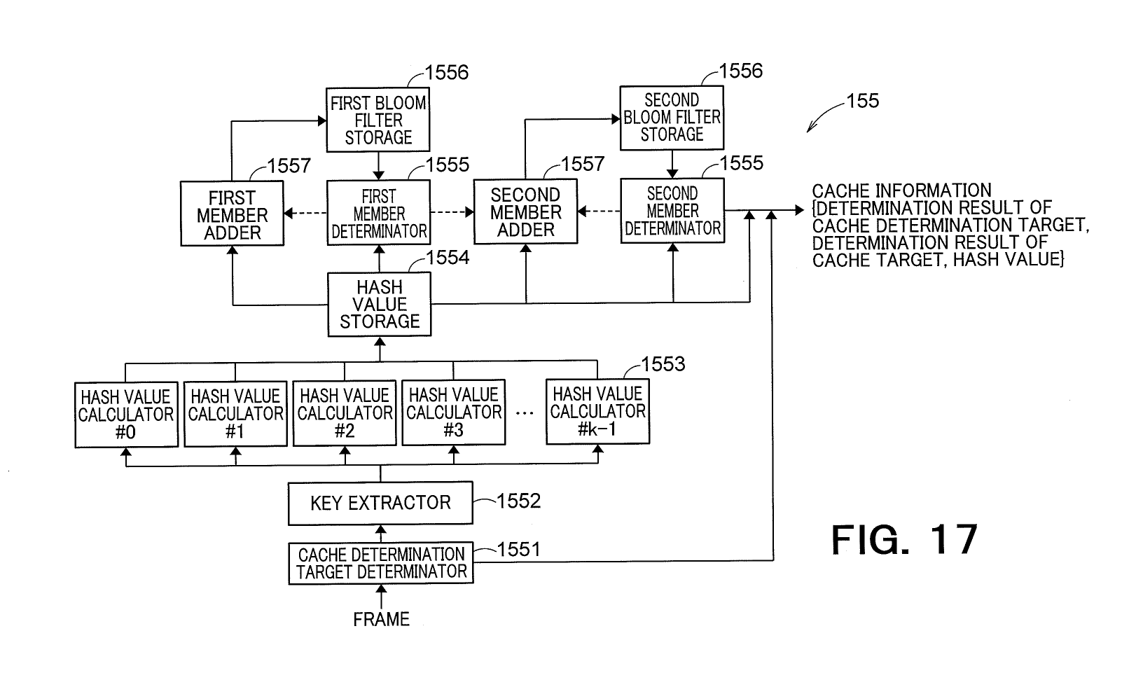

There may be considered as such a configuration that as shown in FIG. 17, the member determinator 1555, the Bloom filter storage 1556, and the member adder 1557 are respectively provided two in number, for example. In an example in FIG. 17, if a first member determinator 1555 determines that the frame is a member of a first Bloom filter, a second member adder 1557 adds the frame as a member of a second Bloom filter. Then, the determination result by the second member determinator 1555 is output as the determination result of the cache determination. With the configuration like this, the communication device 1 performs the cache process in the case where the same content is required three or more times.

Moreover, addition of the member to the Bloom filter stored in the Bloom filter storage 1556 may be performed from the application. For example, an interface by which the application adds a member to the Bloom filter via the device driver may be provided to the member adder 1557.

Further, a counting filter may be used as the Bloom filter in which a counter is provided for each bit. An entry exceeding a certain time period from being used is deleted by means of the counting filter, achieving a function the same as the above described Bloom filter switching.

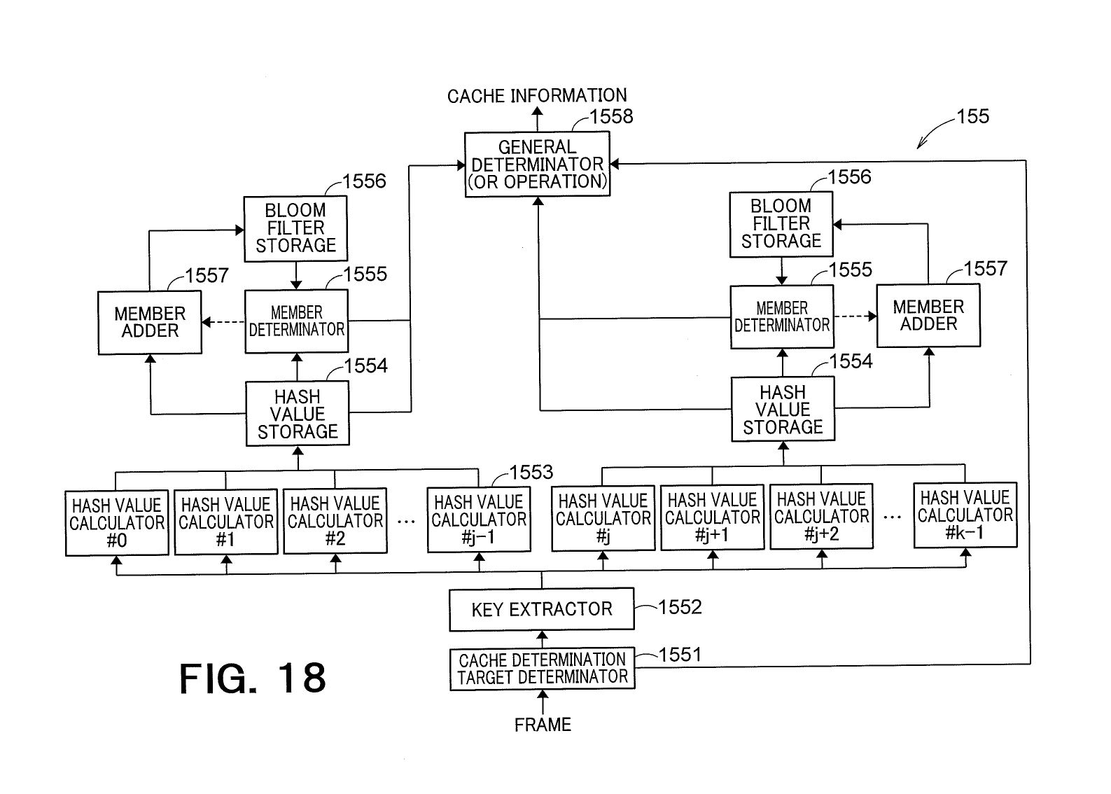

Furthermore, the cache determinator 155 may use plural Bloom filters different in the switching timing. FIG. 18 is a diagram showing a cache determinator 155 including two Bloom filters. In an example in FIG. 18, the cache determinator 155 includes the hash value calculator 1553, hash value storage 1554, member determinator 1555, Bloom filter storage 1556, and member adder 1557 for the cache determination by use of two Bloom filters. The cache determination target determinator 1551 and the key extractor 1552 are used in common. The cache determinator 155 includes a general determinator 1558 for an OR operation of the cache determination result by two Bloom filters. Output from the general determinator 1558 is the cache determination result by the cache determinator 155. In the example in FIG. 18, one Bloom filter is switched every one hour and the other Bloom filter is switched every one GB write amount into the storage, for example.

### Third Embodiment

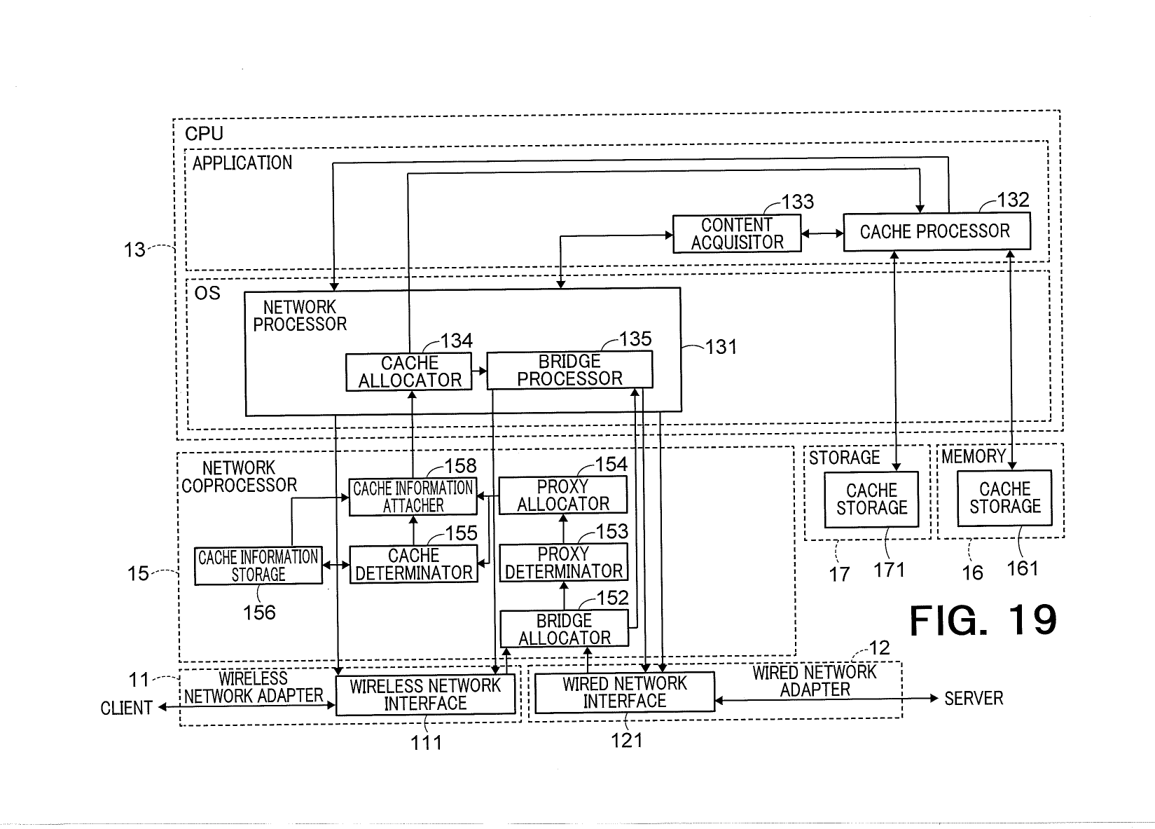

A description is given of the communication device 1 according to a third embodiment with reference to FIG. 19 to FIG. 21. In the embodiment, the communication device 1 not including the TOE 14 is described. FIG. 19 is a diagram showing an example of a functional configuration of the communication device 1 according to the embodiment. As shown in FIG. 19, the communication device 1 according to the embodiment includes a cache information attacher 158, a cache allocator 134, and a bridge processor 135, whereas does not include the cache allocator 157, the network processor 141, and the storage accessor 142. Other configuration is the same as in the first embodiment. A description is mainly given of differences from the first embodiment, below.

In the embodiment, the proxy allocator 154 allocates the frame to any one of the cache information attacher 158 and the cache determinator 155 on the basis of the determination result by the proxy determinator 153. The proxy allocator 154 passes the frame determined to be not the proxy target to the cache information attacher 158 and passes the frame determined to be the proxy target to the cache determinator 155. The proxy allocator 154 passes the frame together with the determination result of the cache determination that the frame is not the cache target to the cache information attacher 158.

The cache information attacher 158 attaches the cache information to the frame to pass the cache allocator 134. The cache information attached by the cache information attacher 158 includes the determination result of the cache determination.

The cache information attacher 158 attaches the determination result received from the proxy allocator 154 to the frame received from the proxy allocator 154. The cache information attacher 158 attaches the determination result output by the cache determinator 155 or the determination result stored in the cache information storage 156 to the frame received from cache determinator 155.

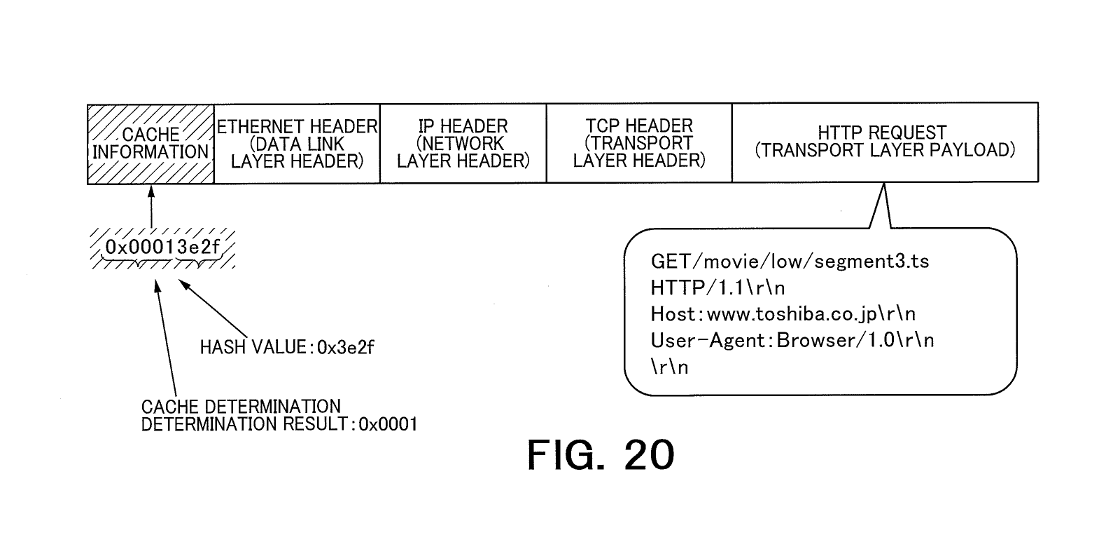

For example, the cache information attacher 158 attaches the determination result of the cache determination and hash value as the cache information to a head of the frame to pass the information to the cache allocator 134, as shown in FIG. 20. The cache information attacher 158 may also describe the cache information in a descriptor of the frame to be passed to the cache allocator 134, instead of attaching the cache information to the frame.

The cache allocator 134 corresponds to the cache allocator 157 in the first embodiment. In other words, in the embodiment, the function of the cache allocator 157 is realized by the network processor 131 in the OS. The cache allocator 134 allocates the frame passed from the cache information attacher 158 to any one of the bridge processor 135 and the cache processor 132 on the basis of the cache information attached to the frame.

More specifically, if the frame is the cache target, the cache allocator 134 subjects the frame to the protocol processes for the network layer and transport layer (reception process) by means of the function of the network processor 131 to pass the frame to the cache processor 132.

At this time, the cache allocator 134 may store the hash value contained in the received cache information as the socket information so as to be taken by the application through the special purpose interface such as ioctl or getsockopt with respect to the socket.

This allows the cache processor 132 to search the cache storage 161 or 171 for the content by use of the hash value taken from the socket information.

On the other hand, if the frame is not the cache target, the cache allocator 134 does not perform the reception process and passes the frame to the bridge processor 135.

The network processor 131 corresponds to the bridge processor 151 in the first embodiment. In other words, in the embodiment, the function of the bridge processor 151 is realized by the network processor 131 in the OS. The bridge processor 135 subjects the frame received from the cache allocator 134 to the bridge process.

Note that, in the embodiment, the network processor 131 performs protocol processes for the network layer and transport layer. Specifically, for example, the network processor 131 performs the protocol processes of an IPv4, IPv6, TCP, UDP (User Datagram Protocol) and the like.

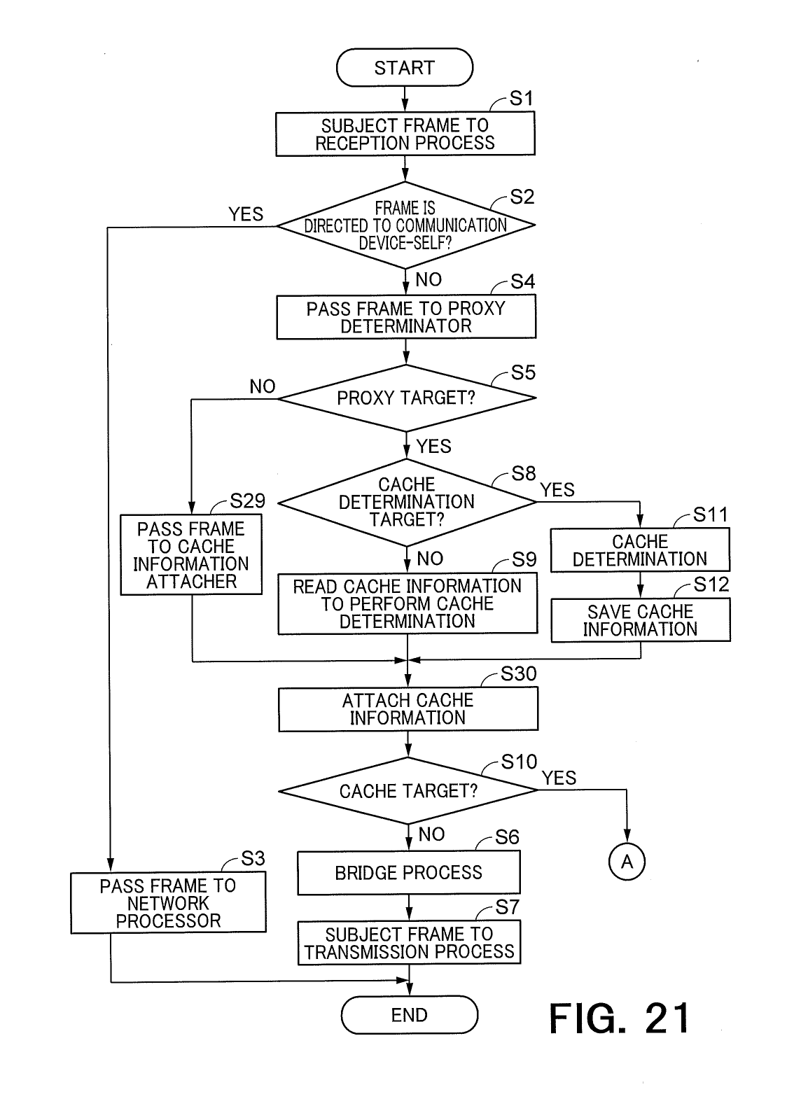

Next, a description is given of an operation of the communication device 1 according to the embodiment with reference to FIG. 21 FIG. 21 is a flowchart showing an example of an operation of the communication device 1 according to the embodiment. The flowchart in FIG. 21 is the same as the flowchart in FIG. 4 except for steps S29 and S30.

In the embodiment, if the frame is not the proxy target (NO at step S5), the proxy allocator 154 passes the frame to the cache information attacher 158 (step S29).

At this time, the proxy allocator 154 passes the determination result of the cache determination that the frame is not the cache target to the cache information attacher 158. This determination result is a dummy and the proxy allocator 154 does not perform the cache determination.

The cache information attacher 158 having received the frame attaches the cache information including the determination result of the cache determination to the frame to pass the frame to the cache allocator 134 (step S30). Since the determination result attached here is false (the determination result that it is not the cache target) (NO at step S10), the cache allocator 134 passes the frame to the bridge processor 135 and the bridge processor 135 subjects the frame to the bridge process (step S6).

On the other hand, if the frame is the proxy target (YES at step S5), the proxy allocator 154 passes the frame to the cache determinator 155. After this, steps S8, S9, S11, and S12 are the same as those in FIG. 4. However, the cache determinator 155 passes the frame to the cache information attacher 158 after the end of the determination. The cache information attacher 158 acquires the cache information output by the cache determinator 155 or the cache information stored in the cache information storage 156.

Then, the cache information attacher 158 attaches the cache information to the acquired frame to pass the frame to the cache allocator 134 (step S30).

If the determination result of the cache determination is false (the determination result that it is not the cache target) (NO at step S10), the cache allocator 134 passes the frame to the bridge processor 135 and the bridge processor 135 subjects the frame to the bridge process (step S6).

On the other hand, if the determination result of the cache determination is true (the determination result that it is the cache target) (YES at step S10), the cache allocator 134 subjects the frame to the reception process to pass the frame to the cache processor 132. Subsequent process is the same as in FIG. 5.

As described above, according to the embodiment, even if the cache determinator 155 to perform the cache determination and the cache allocator 134 to perform or determine the cache process operate on the hardware modules different from each other, the cache information is attached to the frame to allow the frame to be subjected to the process similarly to the first embodiment.

### Fourth Embodiment

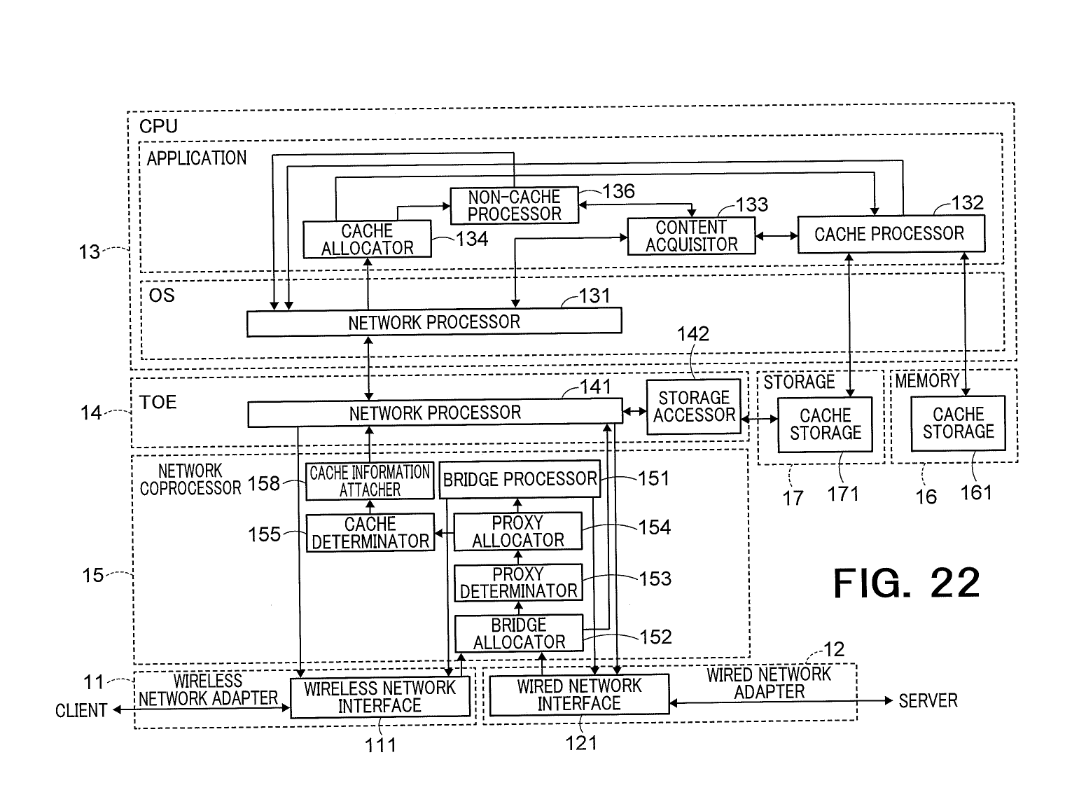

A description is given of the communication device according to a fourth embodiment with reference to FIG. 22 to FIG. 28. FIG. 22 is a diagram showing an example of a functional configuration of the communication device 1 according to the embodiment. As shown in FIG. 22, the communication device 1 according to the embodiment includes the cache allocator 134, a non-cache processor 136, and the cache information attacher 158, whereas does not include the cache information storage 156 and the cache allocator 157. The cache information attacher 158 is the same as in the third embodiment. Other configuration is the same as in the first embodiment. A description is mainly given of differences from the first embodiment, below.

In the embodiment, the frame that is not the proxy target is allocated by the proxy allocator 154 to the bridge processor 151 to be subjected to the bridge process. On the other hand, the frame that is the proxy target is allocated by the proxy allocator 154 to the cache determinator 155.

The cache determinator 155 determines whether or not the frame received is the cache determination target. The frame of the cache determination target is a frame containing the HTTP request, for example.

If the frame is the cache determination target, the cache determinator 155 determines whether or not the frame is the cache target. For example, the cache determinator 155 extracts the key of the frame, calculates the hash values corresponding to the key, and compares the acquired set of hash values with the Bloom filter to determine whether or not the frame is the cache target.

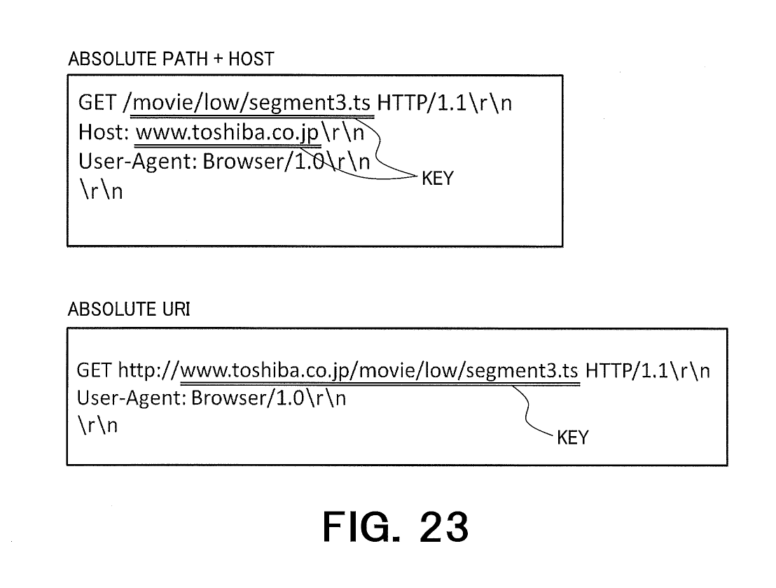

The key may be a destination IP address as described above or may be an absolute path and a host as shown in FIG. 23. In an example in FIG. 23, “movie/low/segment3.ts” and “www.toshiba.co.jp” are extracted as a key.

In addition, since a request is made in a form of an absolute URI if the communication device 1 is made to act as a forward proxy, the key may be an absolute URI as shown in FIG. 23. In the example in FIG. 23, “www.toshiba.co.jp/movie/low/segment3.ts” is extracted as a key.

The cache determinator 155 outputs the frame and the cache information. The cache information includes the determination result of the cache determination target determination, the determination result of the cache determination, and a set of hash values, for example.

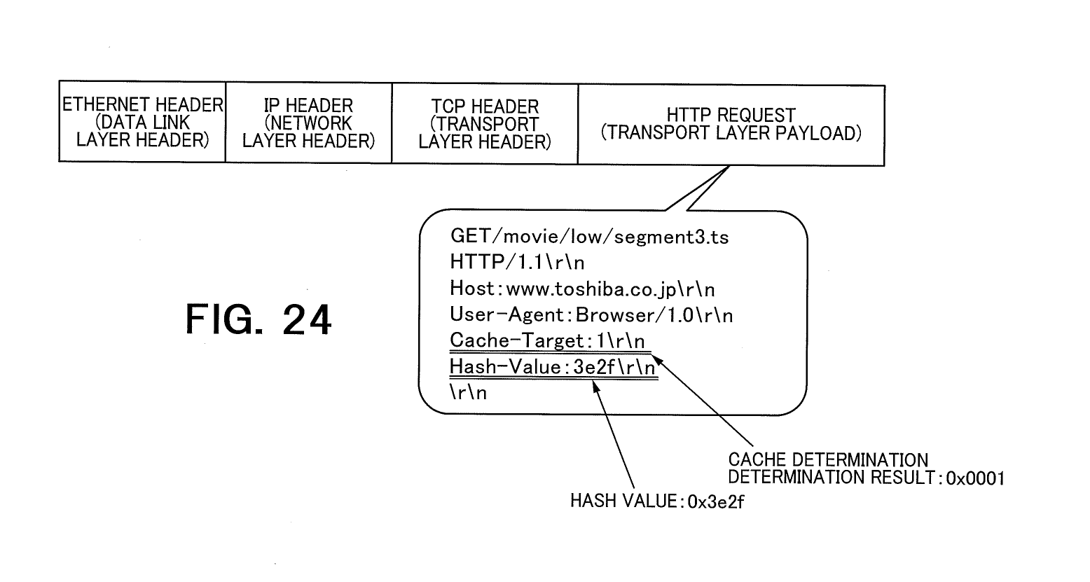

The cache information attacher 158 attaches the cache information to the frame to output. The cache information attacher 158 may attach the cache information to a head of the frame or describes the cache information in a descriptor of the frame, as described above. The cache information attacher 158 may also uniquely define a header in the HTTP request (payload of the TCP) to attach the cache information, as shown in FIG. 24.

The cache information attacher 158 may change the information on the TCP header or IP header such that the frame is normally processed by the network processor 131 or 141 at a later stage. For example, there may be considered that a length of the frame is extended by the additional cache information or a value of the checksum is added by the additional cache information. Moreover, a capacity of the memory for storing the frame may be increased by the additional cache information.

The frame output by the cache information attacher 158 is subjected to the reception process by the network processor 141 or 131 to be passed to the cache allocator 134.

The cache allocator 134 corresponds to the cache allocator 157 in the first embodiment. In other words, in the embodiment, the function of the cache allocator 157 is realized by the application. The cache allocator 134 allocates the frame passed via the network processor 141 or 131 from the cache information attacher 158 to any one of the non-cache processor 136 and the cache processor 132 on the basis of the cache information attached to the frame.

More specifically, if the frame is the cache target (that is, if the determination result of the cache determination attached to the frame is true), the cache allocator 134 passes the frame to the cache processor 132.

On the other hand, if the frame is not the cache target (that is, if the determination result of the cache determination attached to the frame is false), the cache allocator 134 passes the frame to the non-cache processor 136.

The non-cache processor 136, when receiving the frame from the cache allocator 134, establishes a new connection via the content acquisitor 133 with the server 6 to acquire the content required by the client 2 from the server 6. Then, the content acquired from the server 6 is sent in return to the client 2.

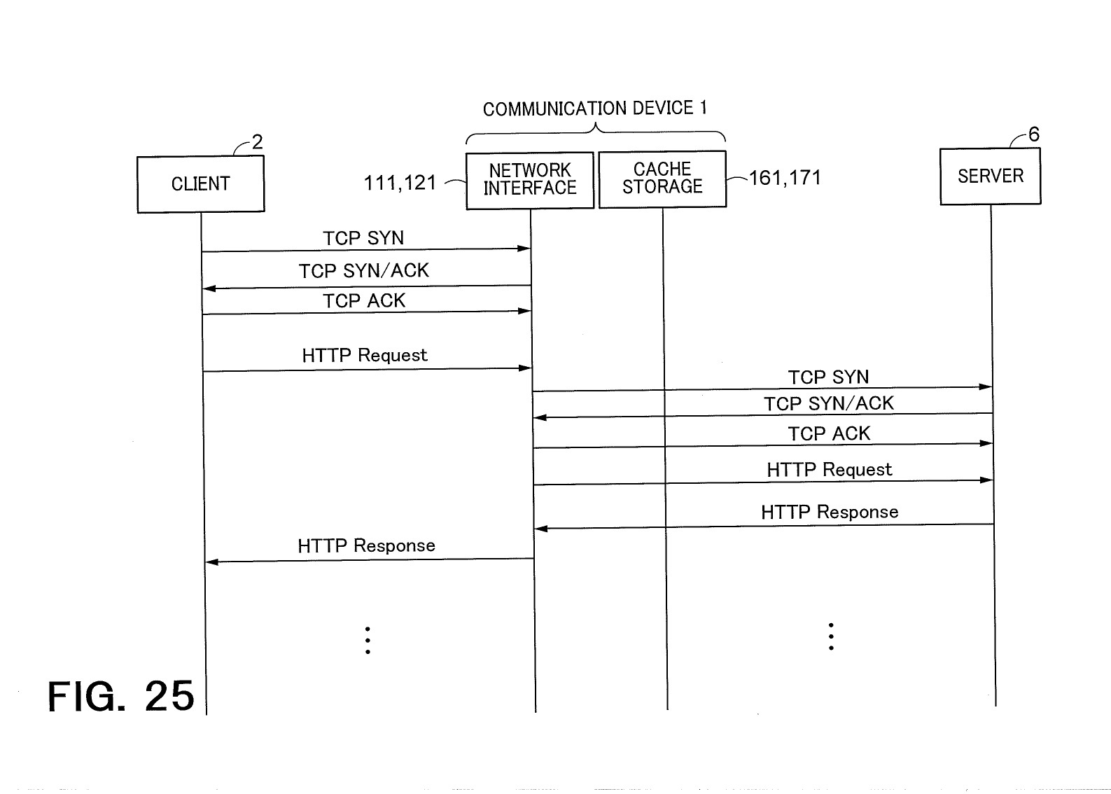

Here, FIG. 25 is a sequence diagram in the case where the frame received by the communication device 1 is the cache determination target, but is not the cache target. In this case, the communication device 1 sends the acquired content to the client 2 without caching it as shown in FIG. 25.

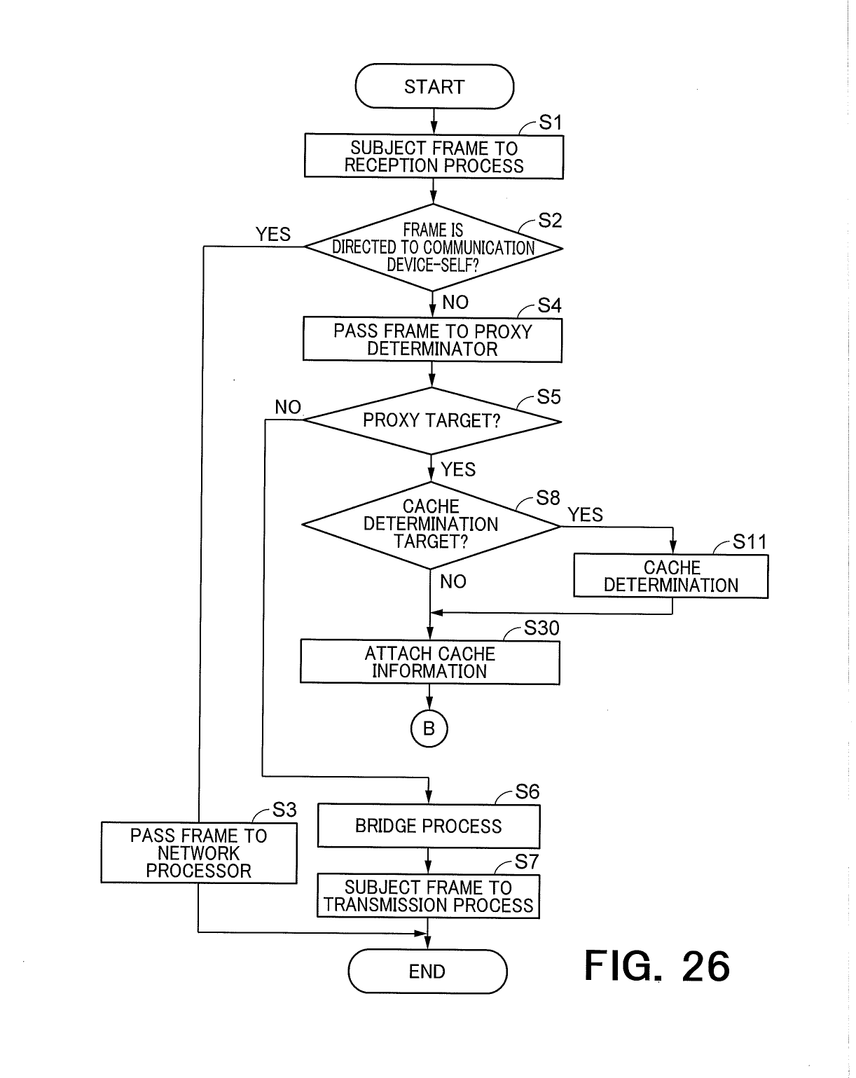

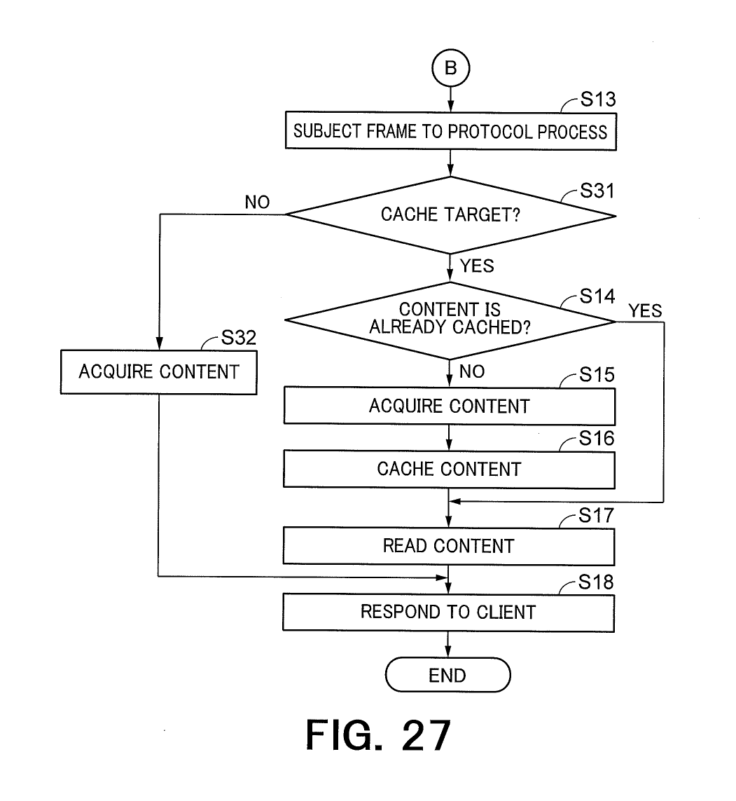

Next, a description is given of an operation of the communication device 1 according to the embodiment with reference to FIG. 26 and FIG. 27. FIG. 26 and FIG. 27 each are a flowchart showing an example of an operation of the communication device 1 according to the embodiment. Steps S1 to S18, S29, and S30 in FIG. 26 and FIG. 27 are the same as the flowchart in FIG. 4, FIG. 5, or FIG. 21.

In the embodiment, the proxy determinator 153 determines whether or not the frame received from bridge allocator 152 is the proxy target to pass the frame and the determination result to the proxy allocator 154 (step S4).

If the frame is not the proxy target (NO at step S5), the proxy allocator 154 passes the frame to the bridge processor 151. Then, the frame is subjected to the bridge process by the bridge processor 151 (step S6).

On the other hand, if the frame is the proxy target (YES at step S5), the proxy allocator 154 passes the frame to the cache determinator 155.

The cache determinator 155 having received the frame determines firstly whether or not the received frame is the cache determination target (step S8).

If the frame is not the cache determination target (NO at step S8), the cache determinator 155 passes the frame and the determination result of the cache determination target determination to the cache information attacher 158. The cache information attacher 158 attaches the cache information to the frame (step S30). The cache information attached here includes the determination result of the cache determination target determination (false).

On the other hand, if the frame is the cache determination target (YES at step S8), the cache determinator 155 performs the cache determination (step S11). Then, the cache determinator 155 passes the frame, the cache determination target determination and the determination result of the cache determination, and the hash value to the cache information attacher 158. The cache information attacher 158 attaches the cache information to the frame (step S30). The cache information attached here includes the determination result of the cache determination target determination (true), the determination result of the cache determination (true or false), and the hash value, for example.

The cache information attacher 158 passes the frame having the cache information attached thereto to the network processor 141. The frame is subjected to a predetermined protocol process by the network processor 141 or 131 to be passed to the cache allocator 134 (step S13).

The cache allocator 134 refers to the cache information to determine whether or not the frame received is the cache target (step S31). If the frame is not the cache target (NO at step S31), that is, if the determination result of the cache determination is false, the cache allocator 134 passes the frame to the non-cache processor 136.

The non-cache processor 136 having received the frame establishes a new connection via the content acquisitor 133 with the server 6 to acquire the content (step S32) and send the acquired content in return to the client (step S18).

On the other hand, if the frame is the cache target (YES at step S31), that is, if the determination result of the cache determination is true, the cache allocator 134 passes the frame to the cache processor 132.

The cache processor 132 having received the frame determines whether or not the content required by the frame is already cached (step S14). After this, the process at steps S14 to S18 is the same as in the first embodiment.

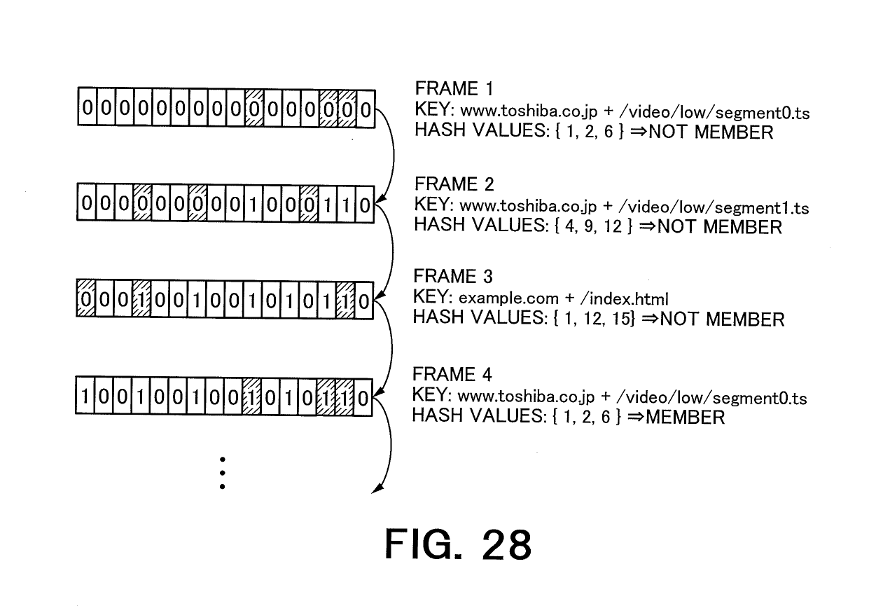

FIG. 28 a diagram showing a specific example of an operation of the cache determinator 155. In an example in FIG. 28, the Bloom filter is a bit array of 16 bits and k=3. Hereinafter, assume that the cache determinator 155 receives the frames 1 to 4 in this order which contain the TCP segment having the destination port number 80. In other words, any of the frames 1 to 4 is the cache determination target. Further, as shown in FIG. 28, it is an example in which the Bloom filter is initialized at the time before receiving the frame. Further, in the following description, a value of the absolute path and host is extracted as a key.

When the cache determinator 155 receives the frame 1, the key extractor 1552 extracts the key (absolute path and host), three hash value calculators 1553 respectively calculate the hash values, and the hash value storage 1554 stores the hash values. Here, assume that the key of the frame 1 is “www.toshiba.co.jp” as the host and “/video/low/segment0.ts” as the absolute path, and the hash values are {1, 2, 6}.

Since the all bit values of the Bloom filter are 0, the hash values {1, 2, 6} for the frame 1 are not contained in the Bloom filter set. Therefore, the member determinator 1555 determines that the frame 1 is not a member. Then, the member adder 1557 adds the frame 1 to the member of the Bloom filter. In other words, the member adder 1557 sets the 1st, 2nd, and 6th bits of the Bloom filter to 1. After that, the hash value storage 1554 is reset. As a result, the frame 1 is processed by the non-cache processor 136, and the content required by the frame 1 is not cached.

When the cache determinator 155 receives the frame 2, the key extractor 1552 extracts the key (absolute path and host), three hash value calculators 1553 respectively calculate the hash values, and the hash value storage 1554 stores the hash values. Here, assume that the key of the frame 2 is “www.toshiba.co.jp” as the host and “/video/low/segment1.ts” as the absolute path, and the hash values are {4, 9, 12}. Since the 1st, 2nd, and 6th bits of the Bloom filter are 1 and other bits are 0, the hash values {4, 9, 12} for the frame 2 are not contained in the Bloom filter set.

Therefore, the member determinator 1555 determines that the frame 2 is not a member. Then, the member adder 1557 adds the frame 2 to the member of the Bloom filter. In other words, the member adder 1557 sets the 4th, 9th, and 12th bits of the Bloom filter to 1. After that, the hash value storage 1554 is reset. As a result, the frame 2 is processed by the non-cache processor 136, and the content required by the frame 2 is not cached.

When the cache determinator 155 receives the frame 3, the key extractor 1552 extracts the key (absolute path and host), three hash value calculators 1553 respectively calculate the hash values, and the hash value storage 1554 stores the hash values. Here, assume that the key of the frame 3 is “example.com” as the host and “/index.html” as the absolute path, and the hash values are {1, 12, 15}.

Since the 1st, 2nd, 4th, 6th, 9th, and 12th bits of the Bloom filter are 1 and other bits are 0, the hash value {15} for the frame 2 is not contained in the Bloom filter set. Therefore, the member determinator 1555 determines that the frame 3 is not a member. Then, the member adder 1557 adds the frame 3 to the member of the Bloom filter. In other words, the member adder 1557 sets the 15th bit of the Bloom filter to 1. The 1st and 12th bits of the Bloom filter are already set to 1, and thus, are not changed. After that, the hash value storage 1554 is reset. As a result, the frame 3 is processed by the non-cache processor 136, and the content required by the frame 3 is not cached.

When the cache determinator 155 receives the frame 4, the key extractor 1552 extracts the key (absolute path and host), three hash value calculators 1553 respectively calculate the hash values, and the hash value storage 1554 stores the hash values. Here, assume that the key of the frame 4 is “www.toshiba.co.jp” as the host and “/video/low/segment0.ts” as the absolute path. In this case, hash values are {1, 2, 6}. The frame 4 corresponds to the second frame (containing an HTTP GET request) requiring the same content as the frame 1.

Since 1st, 2nd, 4th, 6th, 9th, 12th, and 15th bits of the Bloom filter are 1 and other bits are 0, the hash values {1, 2, 6} for the frame 4 are all contained in the Bloom filter set. Therefore, the member determinator 1555 determines that the frame 4 is a member. After that, the hash value storage 1554 is reset. As a result, the frame 4 is processed by the cache processor 132. In other words, the content required by the frame 4 is stored in the cache storage 161 or 171.

After this, when the communication device 1 receives from the client 2 the frame containing the TCP segment having “www.toshiba.co.jp” as the host, “/video/low/segment0.ts” as the absolute path, and the destination port number 80, the cache determination is true, and then, the device 1 sends the content cached in the cache storage 161 or 171 in return to the client 2.

As described above, the communication device 1 according to the embodiment can perform the cache determination for each request even if the same connection is reused to make a request many times like an HTTP Keep Alive request.

Note that the embodiment describes the case where the communication device 1 is made to act as the transparent proxy, but the device 1 may be made to act as the forward proxy or a reverse proxy.

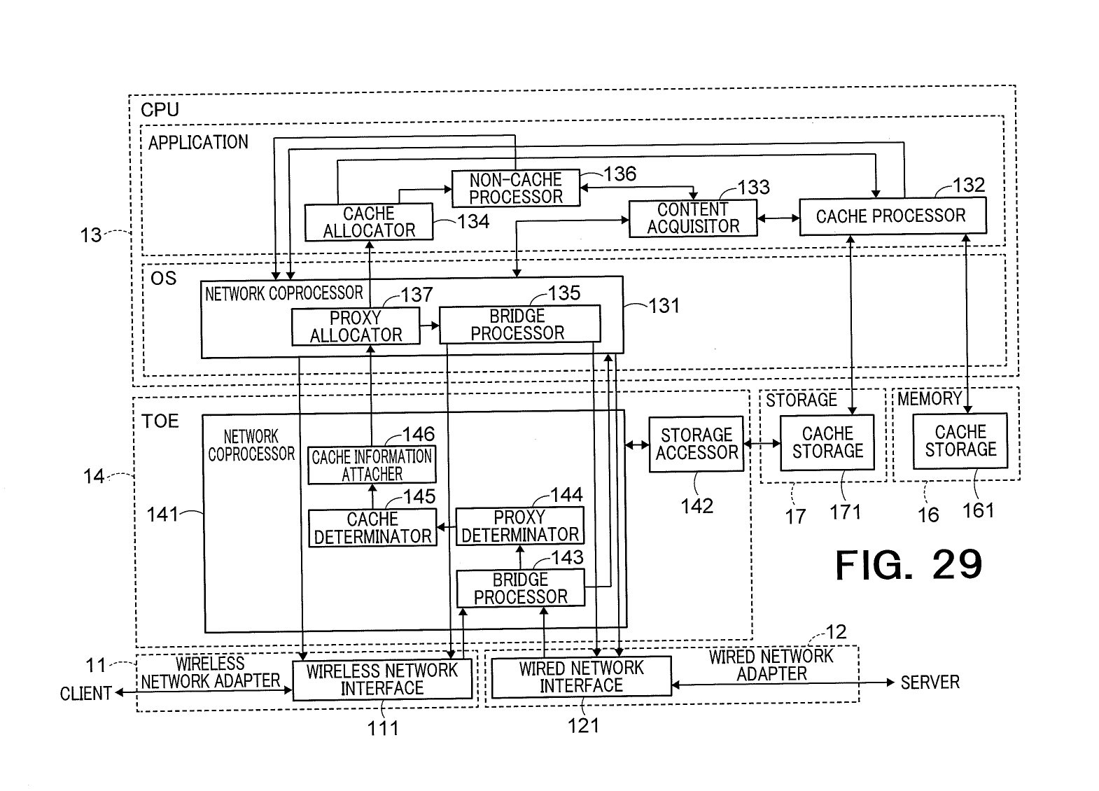

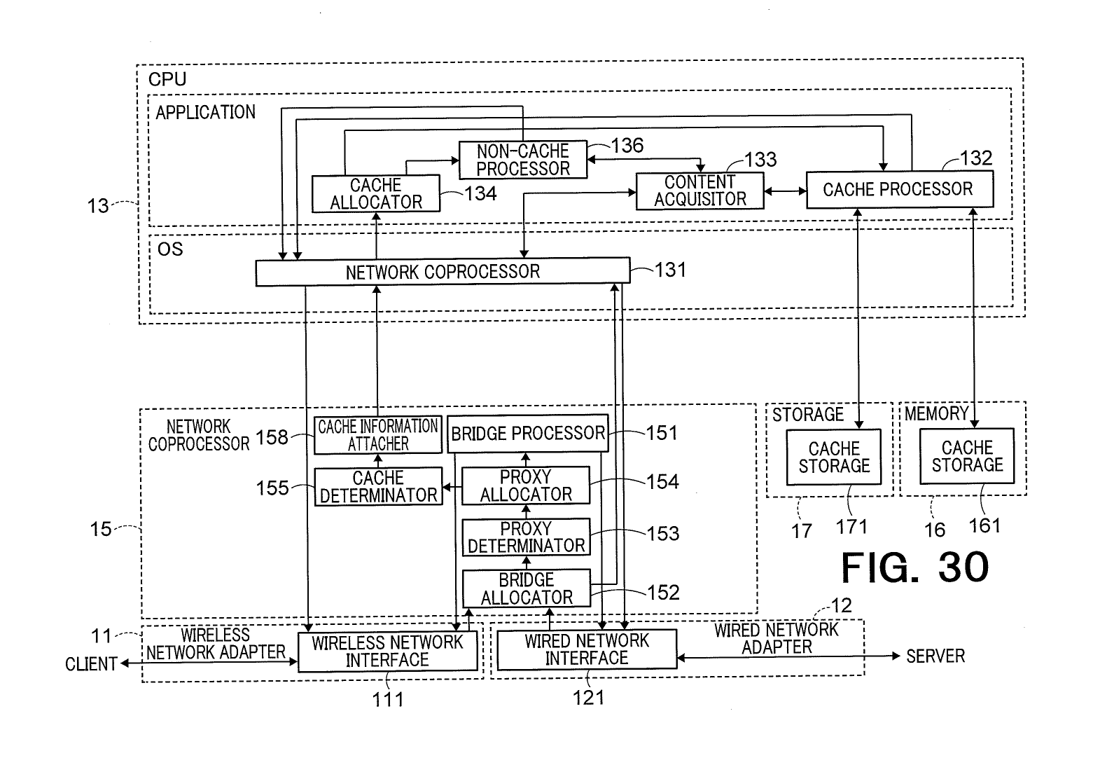

Here, FIG. 29 and FIG. 30 each are a diagram showing a modification example of the communication device 1 in FIG. 22.

FIG. 29 is a diagram showing the communication device 1 in which the function of the network coprocessor 15 in FIG. 22 is realized by the TOE 14 and the OS of the CPU 13. As shown in FIG. 29, in this communication device 1, the network processor 141 includes a bridge processor 143, a proxy determinator 144, a cache determinator 145, and a cache information attacher 146, and the network processor 131 includes the bridge processor 135 and a proxy allocator 137. With the configuration like this, the communication device 1 in FIG. 29 can attain the same function as the communication device 1 in FIG. 22 without using the network coprocessor 15.

FIG. 30 is a diagram showing the communication device 1 in which the function of the TOE 14 in FIG. 22 is realized by the network processor 131 in the OS of the CPU 13. As shown in FIG. 30, this communication device 1 does not include the TOE 14. The network processor 131 performs the protocol process which is performed by the network processor 141 in the communication device 1 in FIG. 22. With the configuration like this, the communication device 1 in FIG. 30 can attain the same function as the communication device 1 in FIG. 22 without using the TOE 14.

### Fifth Embodiment

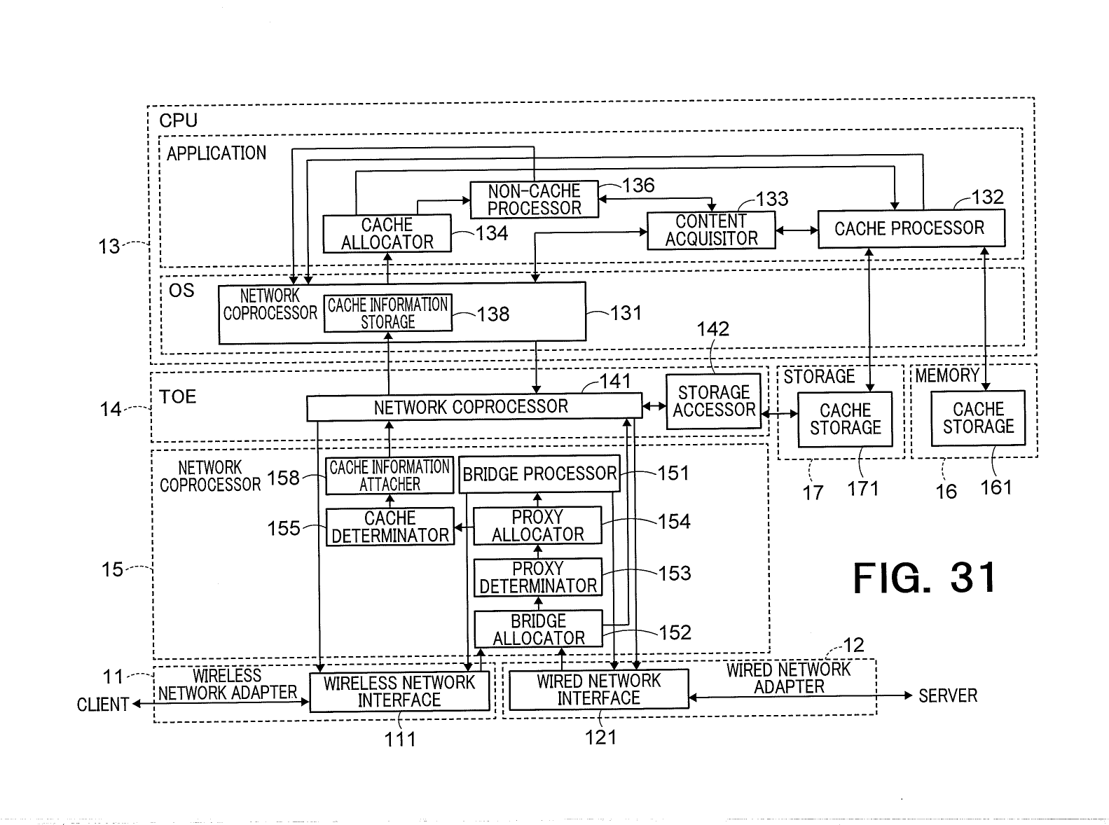

A description is given of the communication device 1 according to a fifth embodiment with reference to FIG. 31 to FIG. 34. FIG. 31 is a diagram showing an example of a functional configuration of the communication device 1 according to the embodiment. As shown in FIG. 31, the communication device 1 according to the embodiment includes a cache information storage 138. Other configuration is the same as in the fourth embodiment. A description is mainly given of differences from the fourth embodiment, below.

In general, a memory area storing the frame has a size of MTU (Maximum Transmission Unit). Since the HTTP request is usually shorter than the MTU, the memory area often has a space (area where the frame is not stored) in a later portion thereof. A certain size of space may be prepared in advance in securing the memory area.

In the embodiment, if the frame is the cache determination target, the cache information attacher 158 attaches the cache information to the above space. The cache information attached here includes the determination result of the cache determination and hash value.

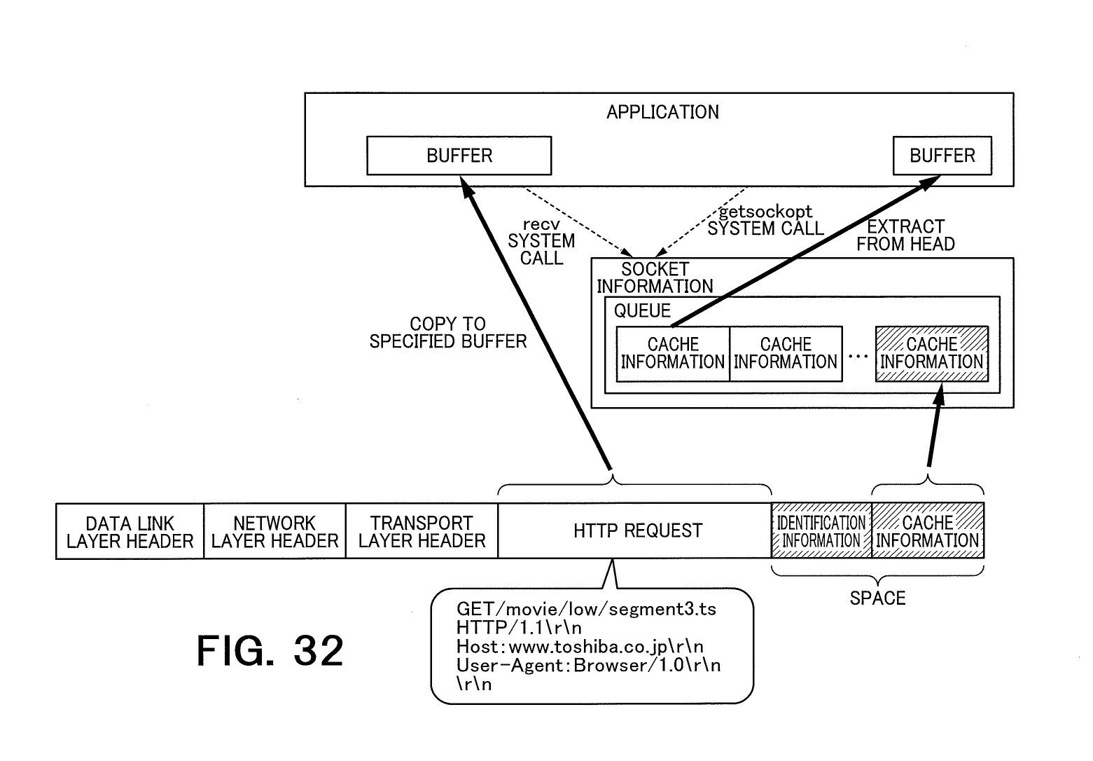

FIG. 32 is a diagram showing an example of a cache information addition method by the cache information attacher 158. In an example in FIG. 32, identification information and the cache information are attached to a later portion of the frame.

The identification information is information of a fixed length indicating presence or absence of the cache information. For example, in the identification information having a length of 1 bit, “1” is stored as the identification information if the cache information is attached and “0” is stored as the identification information if the cache information is not attached.

Note that plural pieces of cache information may be stored in the space in the later portion of the frame or an area for storing a value indicating the number of pieces of cache information stored may be provided in a later portion of the identification information.

The cache information attacher 158 passes the frame having the cache information attached to the network processor 141. The, the frame is subjected to a predetermined protocol process by the network processor 141 or 131.

The cache information storage 138 stores the cache information of the frame subjected to the protocol process by the network processor 131. The cache information storage 138 is constituted by the memory (not shown) in the CPU 13, and stores the cache information as a queue for FIFO (First In First Out).

As shown in FIG. 32, the cache information storage 138 is associated with the socket information which is managed for each socket. The cache information storage 138, when receiving the frame, acquires the cache information attached to the later portion of the frame and adds the acquired cache information to the end of the queue. The cache information may be contained within the socket information or may be connected from the socket information by a pointer or the like.

The cache allocator 134 can use a system call such as ioctl or getsockopt with respect to the socket to read out the cache information from a head of the queue of the cache information storage 138 associated with the specified socket information.

Therefore, the cache allocator 134 can acquire by recv the frame from the client 2, acquire by getsockopt the head cache information from the queue if the HTTP request is contained in the acquired frame, determine whether or not the frame is to be subjected to the cache process on the basis of the acquired cache information, and allocate the frame to one of the cache processor 132 and the non-cache processor 136.

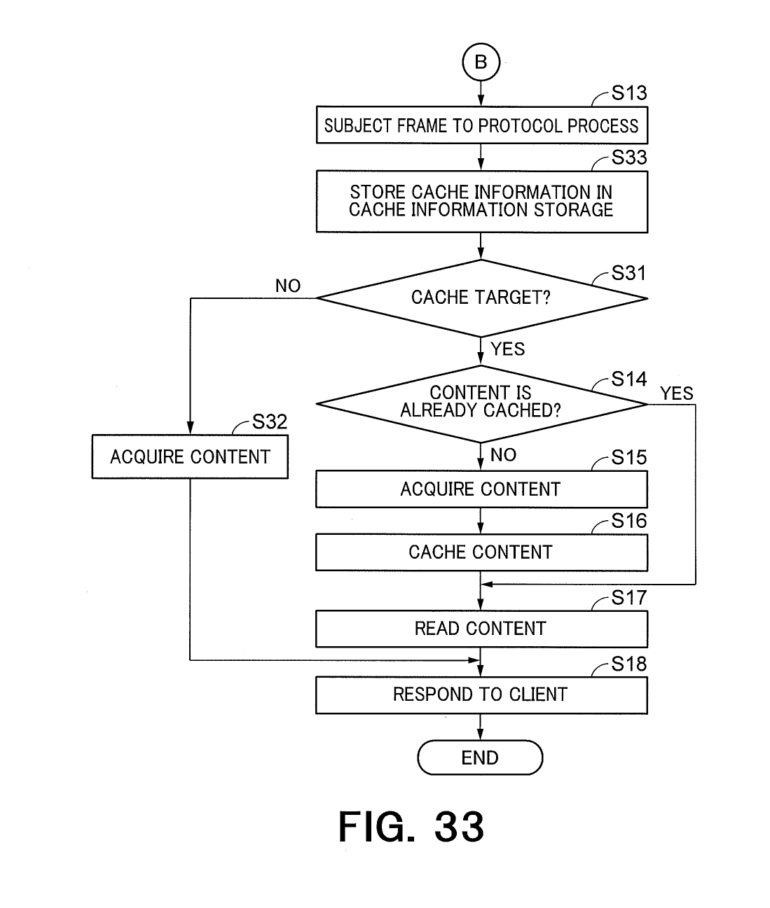

Next, a description is given of an operation of the communication device 1 according to the embodiment with reference to FIG. 33. FIG. 33 is a flowchart showing an example of an operation of the communication device 1 according to the embodiment. The operation until “B” in FIG. 33 is the same as in the flowchart in FIG. 26.

As shown in FIG. 26, in the embodiment, after the network processor 141 or 131 subjects the frame to the protocol process, the cache information storage 138 stores the cache information attached to the later portion of the frame (step S33). Whether or not the cache information is attached may be determined by confirming a value of the identification information at the later portion of the frame.

After that, the cache allocator 134 acquires by the system call such as getsockopt the cache information from the cache information storage 138, and reads out the determination result of the cache determination and the hash value to determine whether or not the frame is the cache target (step S31). If the frame is the cache target (YES at step S31), the cache allocator 134 passes the frame to the cache processor 132. On the other hand, if the frame is not the cache target (NO at step S31), the cache allocator 134 passes the frame to the non-cache processor 136. Subsequent process is the same as in the flowchart in FIG. 27.

As described above, the communication device 1 according to the embodiment can attach the cache information in the space in the later portion of the frame, store the attached cache information to the cache information storage 138, read out the stored cache information by the system call, and determine whether or not to perform the cache process on the basis of the read cache information. This allows an overhead for the process to be reduced such as a path of the HTTP, a checksum operation.

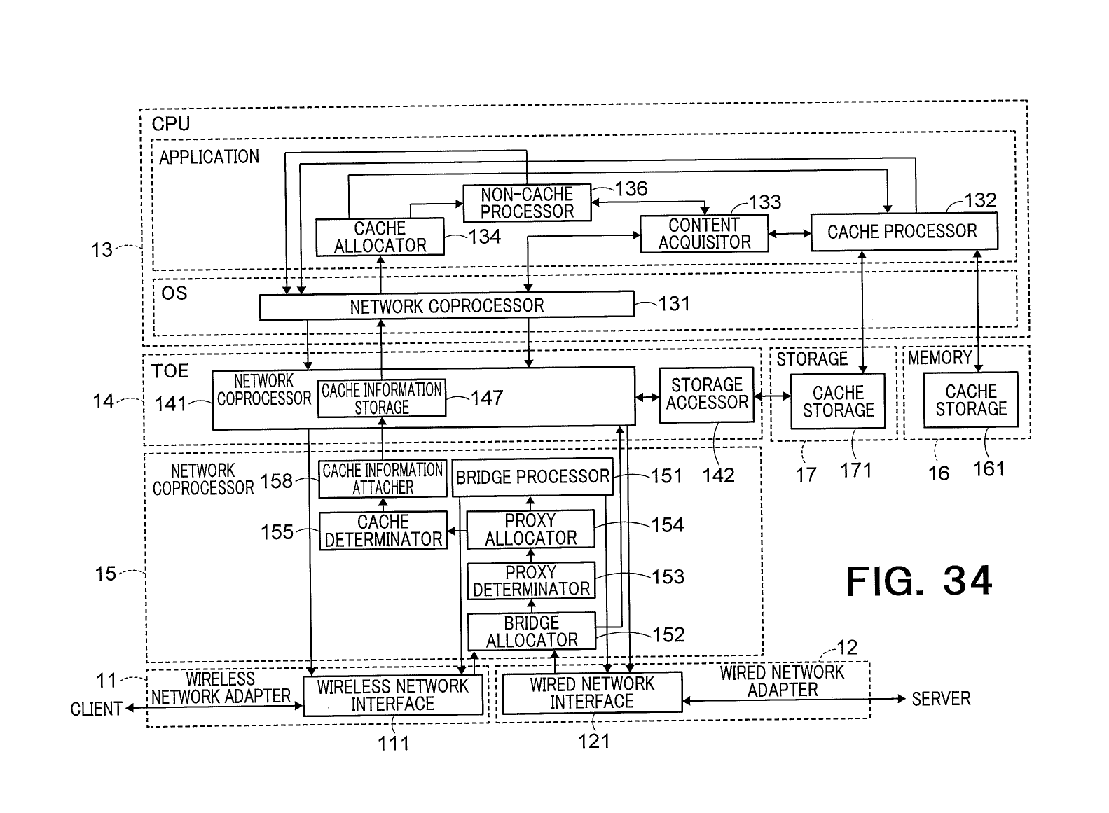

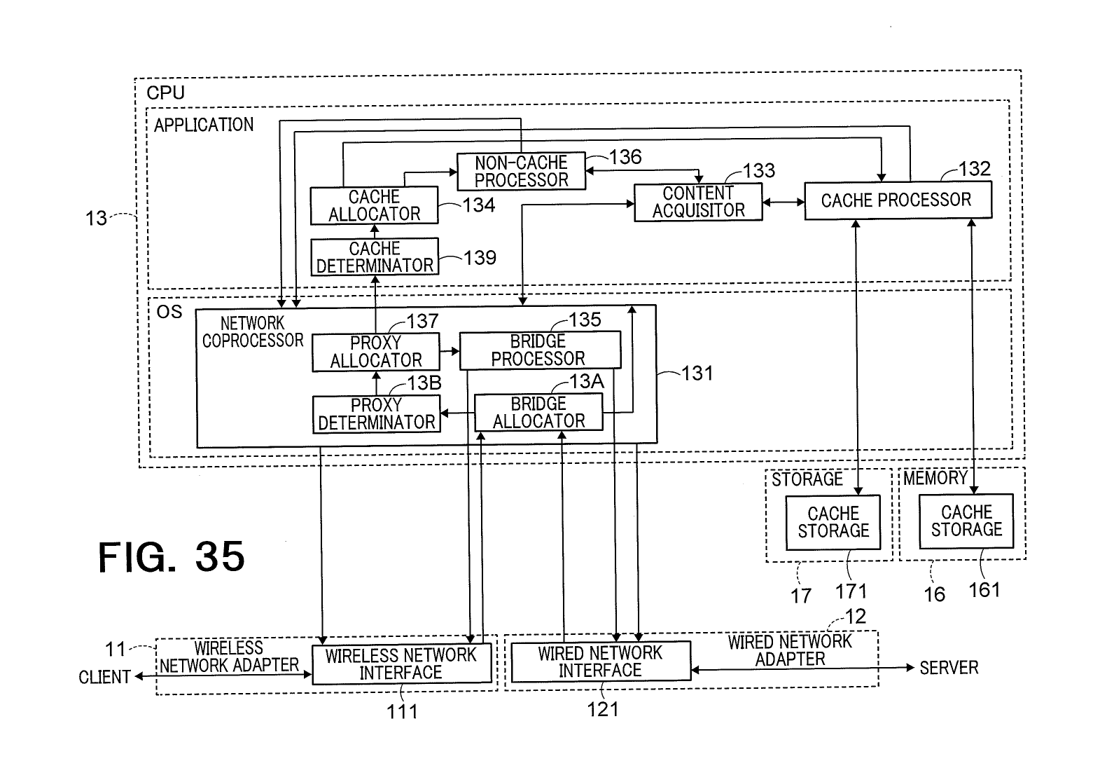

FIG. 34 is a diagram showing a modification example of the communication device 1 according to the embodiment. In the communication device 1 in FIG. 34, instead of that the network processor 131 includes the cache information storage 138, the network processor 141 includes a cache information storage 147. Even the configuration like this can attain the same function as the communication device 1 in FIG. 31.

### Sixth Embodiment

A description is given of the communication device 1 according to a sixth embodiment with reference to FIG. 35 to FIG. 37. The communication device 1 according to the embodiment does not include the TOE 14 and the network coprocessor 15, the functions of these are all realized by the application or OS of the CPU 13. FIG. 35 is a diagram showing an example of a functional configuration of the communication device 1 according to the embodiment.

As shown in FIG. 35, the communication device 1 according to the embodiment includes the cache processor 132, the content acquisitor 133, the cache allocator 134, the non-cache processor 136, and a cache determinator 139. These functions are realized by the application of the CPU 13.

The communication device 1 also includes the network processor 131, the bridge processor 135, the proxy allocator 137, a bridge allocator 13A, and a proxy determinator 13B. These functions are realized by the OS of the CPU 13.

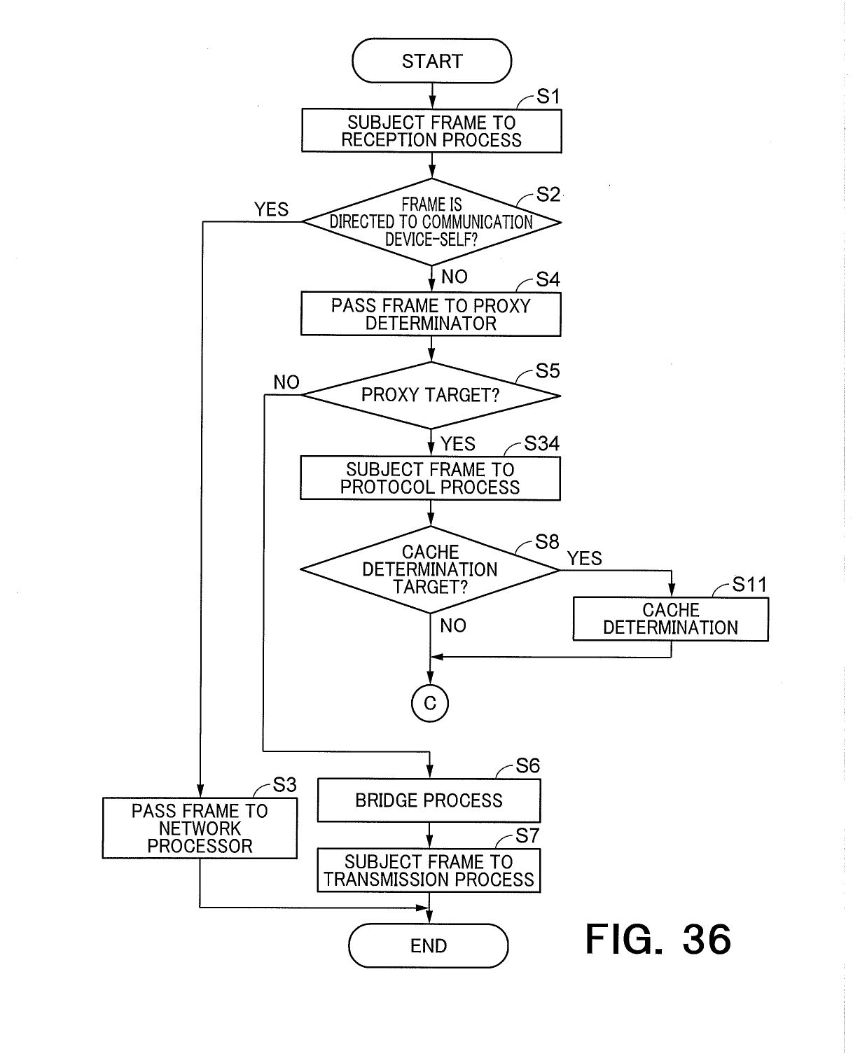

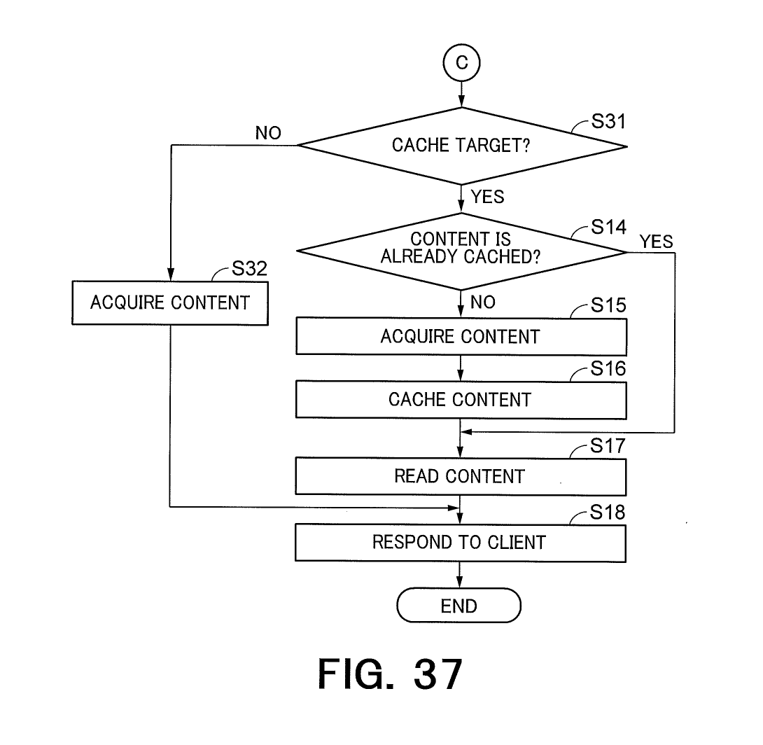

Next, a description is given of an operation of the communication device 1 according to the embodiment with reference to FIG. 36 and FIG. 37. FIG. 36 and FIG. 37 each are a flowchart showing an example of an operation of the communication device 1 according to the embodiment.

As shown in FIG. 36, in the embodiment, if the frame is not the proxy target (NO at step S5), the proxy allocator 137 passes the frame to the bridge processor 135.

After that, the frame is subjected to the bridge process by the bridge processor 135 (step S6).

On the other hand, if the frame is the proxy target (YES at step S5), the network processor 131 subjects the frame to the protocol process (step S34) and the proxy allocator 137 passes the frame to the cache determinator 139.

The cache determinator 139 determines whether or not the passed frame is the cache determination target (step S8), and, if it is the cache determination target (YES at step S8), subjects the frame to the cache determination (step S11). After that, the cache determinator 139 passes the frame and the cache information to the cache allocator 134.

If the frame is the cache target (YES at step S31), the cache allocator 134 passes the frame to the cache processor 132. After that, the cache processor 132 determines whether or not the content is already cached (step S14). Subsequent process is the same as in the flowchart in FIG. 33.

On the other hand, if the frame is not the cache target (NO at step. S31), the cache allocator 134 passes the frame to the non-cache processor 136. After that, the content acquisitor (or content acquirer) 133 acquires the content (step S32) and responds to the client (step S18).

As described above, the communication device 1 according to the embodiment can attain the functions of the cache determinator 139 and cache allocator 134 by the application executing on the CPU 13. For this reason, in a case where the CPU 13 has a multi-core or many-core installed therein, the cache determination can be performed at a high speed without using special hardware.

Note that the communication device 1 according to the embodiments described above is assumed to operate as the access point in the wireless LAN, and thus, includes the wireless network adapter 11 for connecting with the client 2 and the wired network adapter 12 for connecting with server 6. However, the communication device 1 may include two wireless network adapters 11 respectively connecting with the client 2 and the server 6, or two wired network adapters 2 respectively connecting with the client 2 and the server 6. Additionally, the device 1 may be connected to plural networks by a single wireless network adapter 11 or wired network adapter 12 by use of a VLAN defined by the IEEE 802.1q or the like.

Further, the case of the HTTP version 1.1 is described above, but the version may be 1.0 or 2.0. For example, in a case of the HTTP 2.0, one frame contains plural requests, and therefore, the number of keys is plural. In this case, the plural pieces of cache information may be stored in the cache information storage by means of an array or the like. The same goes for the case where the cache information is attached to the frame. In contrast, in a case where the request is divided for the plural frames, a buffer may be provided to couple the plural frames before performing the process.

Furthermore, the protocol at the transport layer is the TCP in the above description, but the protocol may be the UDP or a QUIC.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A communication device comprising:
a network interface configured to receive a frame from a client;
first circuitry configured to determine whether or not the frame is a cache target which requires same content a predetermined number of times or more within a predetermined time period; and
second circuitry configured to cache the content required by the frame in a case where the frame is the cache target.

2. The communication device according to claim 1,
wherein the first circuitry determines whether or not the frame is the cache target on the basis of at least one of a destination IP address, an absolute URI, a host, and an absolute path which are contained in the frame.

3. The communication device according to claim 1,
wherein the first circuitry uses a Bloom filter to determine whether or not the frame is the cache target.

4. The communication device according to claim 3,
wherein the first circuitry switches the Bloom filter used, at a predetermined timing.

5. The communication device according to claim 1, wherein:
the first circuitry attaches cache information including a determination result to a head of the frame, in a TCP payload, or to a later portion of the frame.

6. The communication device according to claim 5,
wherein the cache information includes a hash value which is calculated from at least one of the destination IP address, the absolute URI, the host, and the absolute path contained in the frame.

7. The communication device according to claim 5,
wherein the cache information is managed in unit of a socket and associated with the socket to be stored.

8. The communication device according to claim 5,
wherein the cache information is stored as a queue for first-in, first-out.

9. The communication device according to claim 1,
wherein the first circuitry includes plural hash value calculators which operate in parallel and each calculate a hash value.

10. The communication device according to claim 1,
wherein in a case where the content is already cached, the cache processor sends the cached content in return to the client.

11. The communication device according to claim 1,
wherein the first circuitry is constituted by hardware module different from a host processor.

12. A communication method comprising:
receiving a frame from a client;
determining whether or not the frame is a cache target which requires same content a predetermined number of times or more within a predetermined time period; and
caching the content required by the frame in a case where the frame is the cache target.

13. A non-transitory computer readable medium, having a program stored therein which when executed by a computer, causes the computer to execute processing comprising:
receiving a frame from a client;
determining whether or not the frame is a cache target which requires same content a predetermined number of times or more within a predetermined time period; and
caching the content required by the frame in a case where the frame is the cache target.
